(19) United States
(12) Patent Application Publication
(10) Pub. No.: US 2017/0255978 A1
(43) Pub. Date: Sep. 7, 2017

(54) SYSTEM, APPARATUS AND METHOD FOR GENERATING A PROPOSED STATE ANALYSIS

(71) Applicant: Kenji HAGIWARA, Edgewater, NJ (US)

(72) Inventor: Kenji HAGIWARA, Edgewater, NJ (US)

(73) Assignee: RICOH COMPANY, LTD., Tokyo (JP)

(21) Appl. No.: 15/062,521

(22) Filed: Mar. 7, 2016

(51) Int. Cl. G06Q 30/06; G06Q 10/08

(52) U.S. Cl. CPC G06Q 30/0611; G06Q 10/0875

(57) ABSTRACT

Tools, such as a system, apparatus, methodology, application, etc., are provided for generating a proposed state analysis, and include provisions to generate a proposed state analysis based on another proposed state analysis or based on a current state analysis of a current fleet of devices.

### TECHNICAL FIELD

This disclosure relates to tools (e.g., system, apparatus, methodology, application, etc.) for generating a proposed state analysis, and more specifically, such tools including provisions to generate a proposed state analysis based on another proposed state analysis or based on a current state analysis of a current fleet of devices.

### BACKGROUND

In the current information age, information technology (IT) tools are extensively used in enterprises and other organizations in order to facilitate communication and processing of information, documents, data, etc. Indeed, it is now rare to find a workflow in an enterprise that does not employ IT tools. The number of IT assets [such as software, computers, printers, scanners, multi-function devices (MFDs), other network-connected or standalone devices] is generally increasing and, as a result, managing IT assets to meet enterprise needs is becoming a daunting task.

One approach for a vendor to make an educated and intriguing sales pitch to a customer or prospective customer is to present a proposal along with an analysis of the current IT expenditures of the customer or prospective customer. For example, a customer may wish to know, and a current state analysis may be prepared to show, total cost of ownership, or expected expenditures (such as for consumables) for devices [e.g., printers, scanners, facsimile devices, multi-function peripherals (MFP), etc.] for each period of one or more months, a year, 3 years, etc., output volumes, etc. Accordingly, the vendor typically attempts to determine the current IT assets of the customer or prospective customer and then collate information such as, but not limited to, acquisition type (i.e. lease/purchase), acquisition cost, depreciation of product, service cost, and in the case of printing products/services, consumables (e.g., paper, ink, toner, etc.) usage or cost, output, etc. Further, the vendor may analyze the needs of the customer or prospective customer in order to be able to offer a package of products and/or services that is attractive to the customer or prospective customer.

However, since a virtually infinite number of candidate devices are typically available in the market for consideration, there exists a need for an improved approach for compiling and presenting a proposed fleet of devices for consideration.

### SUMMARY

Various tools (e.g., systems, apparatuses, methodologies, computer program products, application software, etc.) can be configured to include any combination of various aspects and features described herein, to perform a proposed state analysis of a proposed fleet of devices. Such tools can be employed by sales or marketing personnel, as well as by a customer, in a case of new sale, as well as in the instance of contract renewal, to obtain a proposed state analysis of a proposed fleet of devices for the customer. The proposed state analysis may be based on, and compared to, a current state analysis of the current fleet of devices employed by the customer or a customer site, so that the customer can more readily understand the difference between proposed state and current state.

Such tool provides a user interface (UI) to permit a user to select a fleet of devices from (a) a current state analysis for a current fleet of image forming devices in an enterprise or enterprise site or (b) a registered state analysis for a proposed fleet of image forming devices. The user interface also permits the user to revise the selected fleet of devices, including UI parts to add devices to, modify devices in, and remove devices from the fleet of devices. The tool also includes a fleet analysis module that generates a proposed state analysis for the specified fleet of devices.

Any one or more aspects discussed herein may be included in the aforementioned tool. For example, the proposed state may be based on a current state analysis while maintaining approximately the same mono and/or color volumes, and/or the same number of devices, and/or the same devices as much as possible. As another aspect, after a proposed state is created, the user can modify it (e.g., add new devices, modify existing devices, remove existing devices, etc.) as desired or necessary. In another aspect, a proposed state can be created from scratch (i.e. without benefit of a current state or a pre-existing proposed state), in case of new customer or prospective customer, etc.

In another aspect, any one or more precanned proposed states may be generated based on the current state analysis, upon user command, such as, for example, (i) just extending the current contract with same models but different prices, (ii) new models for mono devices only, (ii) new models for mono and color devices, etc.

In another aspect, the user interface can be configured to permit the user to specify multiple state analyses and retrieve them for side-by-side comparison.

Each of the aforementioned analyses may be performed for the enterprise or organization as a whole, for a particular Site, for a particular building, for a particular floor, for a particular workgroup, for a particular business unit, for a particular department, for a particular cost center level, etc.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of a system, according to an exemplary embodiment, for generating a proposed state analysis;

FIG. 1B shows a block diagram of a system, according to another exemplary embodiment for generating a proposed state analysis;

FIG. 1C shows a block diagram of a system, according to another exemplary embodiment for generating a proposed state analysis;

FIG. 2 shows a block diagram of an exemplary configuration of a computing device that can be configured by software to constitute a server;

FIG. 3 shows a block diagram of an exemplary configuration of a terminal or computer that can host one or more applications;

FIG. 4 shows a block diagram of an exemplary configuration of a multi-function device;

FIG. 5 shows a schematic diagram of an example of communication flow in any of the systems shown in FIGS. 1A-1C;

FIG. 6 shows a schematic diagram of an example of communication flow in any of the systems shown in FIGS. 1A-1C;

FIG. 7 shows a flow chart of a method that can be performed in any of the systems shown in FIGS. 1A-1C;

FIG. 8 shows a graphical representation of distribution of offices of a multinational corporation, according to an example;

FIGS. 9A-9H-5 show examples of user interface screens that can be provided by a device fleet analysis application, according to an exemplary embodiment;

FIG. 10 shows a flow chart of a method that can be performed in any of the systems shown in FIGS. 1A-1C;

FIGS. 11A-11G show examples of user interface screens that can be provided by a device fleet analysis application, according to an exemplary embodiment;

FIG. 12 shows a flow chart of a method that can be performed in any of the systems shown in FIGS. 1A-1C; and

FIGS. 13A-13C show examples of user interface screens that can be provided by a device fleet analysis application, according to an exemplary embodiment.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools to facilitate a proposed state analysis are discussed herein, with reference to a device fleet analysis application. It should be appreciated by those skilled in the art that any one or more of such tools may be embedded in another application (e.g., a device marketing application, etc.) and/or in any of various other ways, and thus while various examples are discussed herein, the inventive aspects of this disclosure are not limited to such examples described herein.

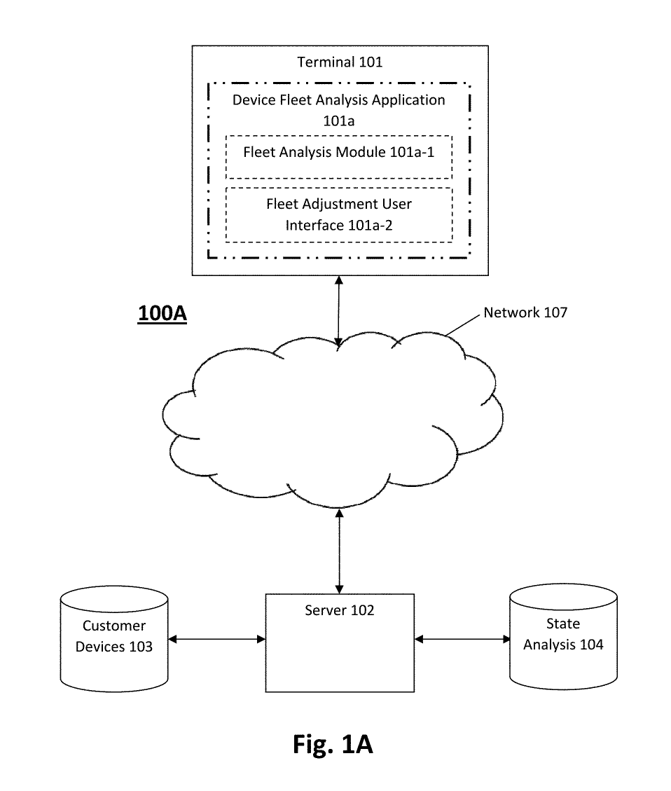

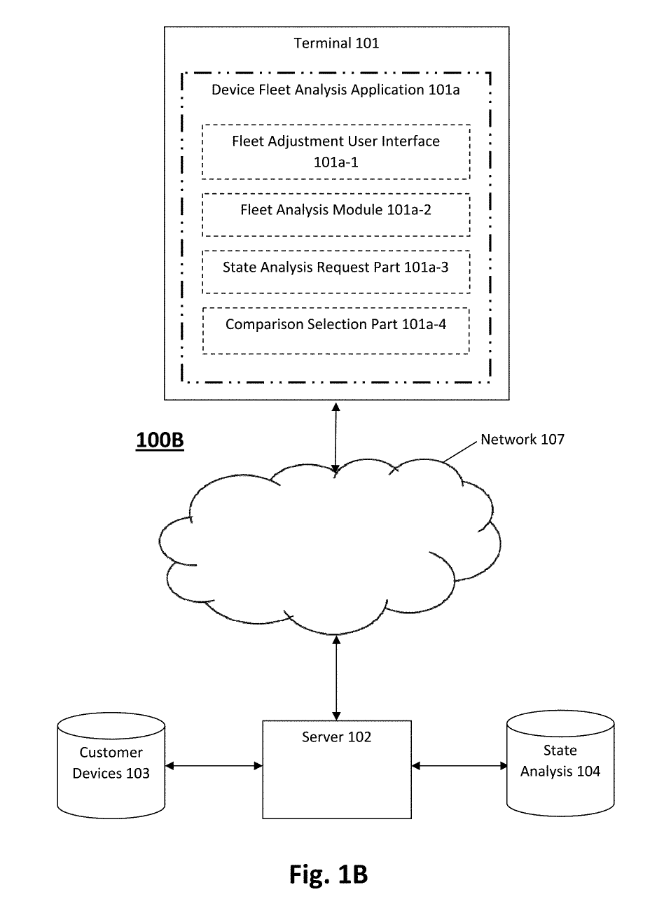

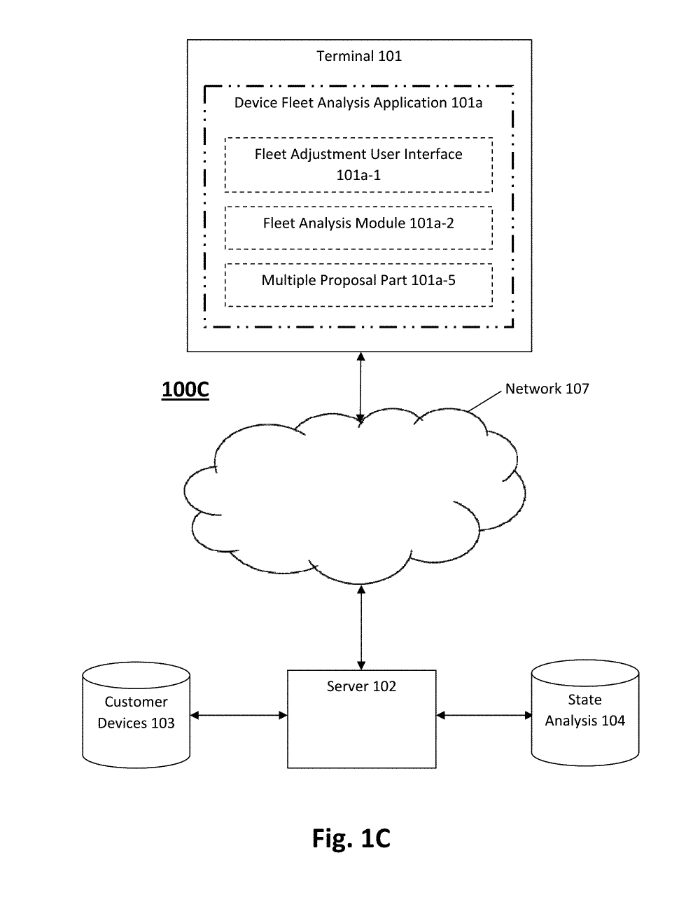

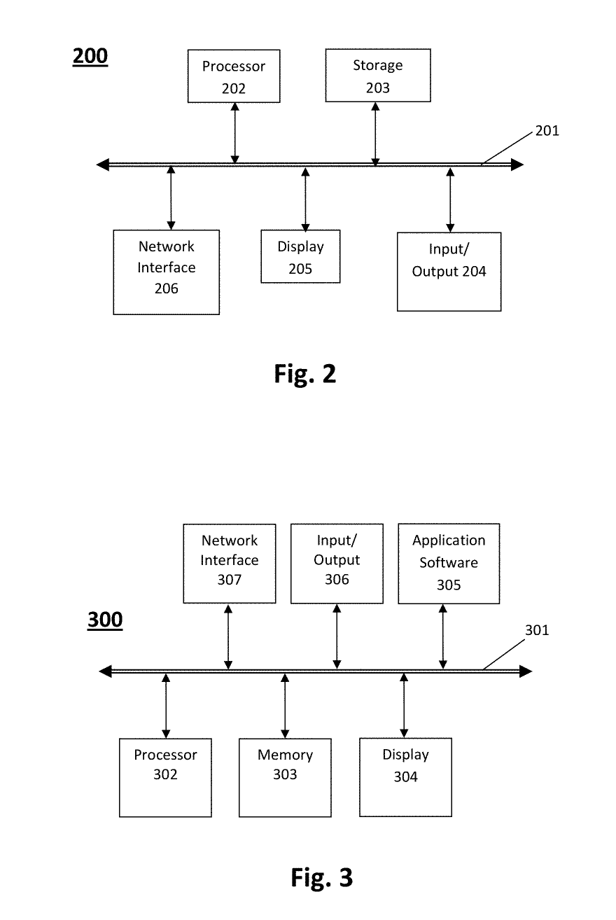

FIG. 1A shows schematically a system 100A that includes a terminal 101 and a server 102, which are interconnected by network 107. Although only one terminal is shown in FIG. 2A, it should be understood that the system 100A can include a plurality of terminal devices (which can have similar or different configurations).

The terminal 101 can be any computing device, including but not limited to a personal, notebook or workstation computer, a kiosk, a PDA (personal digital assistant), a mobile phone or handset, another information terminal, etc., that can communicate with other devices through the network 107. The terminal 101 is further described infra with reference to FIG. 3.

Device fleet analysis application 101a is hosted on the terminal 101 and is configured to perform analysis and calculations with regards to a set (or fleet) of one or more specified devices. Such analysis may be performed on an existing set of devices (e.g., a fleet of devices employed by a particular organization) or a proposed set of devices (e.g., a list of devices recommended to a particular organization for purchase, lease, etc.). The analysis may include determining (i) the total cost of ownership (TCO) of the set of one or more devices, (ii) the resources (e.g., paper, ink, energy, toner, etc.) consumed by each devices, and (iii) the output (i.e. pages, CO2, etc.) generated by use of each of the devices. Such analysis may be performed for the purpose of determining a set of devices that can meet the needs of a customer, in an optimal manner preferably.

For example, it may be that a specific customer has requested to purchase devices from a company that employs the user of the terminal 101. In response, the user may ask for the devices currently possessed (e.g., purchased, leased, etc.) by the specific customer. The user may want to know this information since he or she may be able to understand better the needs of the customer from the devices currently possessed. In one case, it may be that the specific customer is an art museum that possesses an entire fleet of devices that can perform color printing. In such case, the user of the terminal 101 is probably not going to recommend devices that print only in black-and-white to the specific customer.

The list of devices currently possessed by the specific customer may be sent to the user in various forms. For example, the specific customer may send the list of current devices to the user in an electronic format (e.g., spreadsheet, e-mail, etc.) or by paper (e.g., handwriting, typed, etc.). In another example, the specific customer may simply tell the user (e.g., meetings, telephone conference, etc.) what devices the specific customer currently possesses. After receiving information regarding the current devices from the specific customer, the user can utilize the device fleet analysis application 101a to create a current state analysis which includes (i) the list of devices currently possessed by the customer and (ii) an analysis (e.g., TCO, resource consumption, waste generation, etc.) of the list of devices. It should be noted that the analysis may be performed for each device and/or the entirety of the devices at a site (e.g., total waste generated by the site, total resource consumption of the site, etc.).

The fleet analysis module 101a-1 generates a proposed state analysis which may be (i) a list of one or more devices (e.g., printer, MFP, scanner, facsimile machine, etc.) that may be recommended by the user of the terminal 101 to a particular customer and (ii) an analysis of those devices (e.g., TCO, resource consumption, waste generation, etc.) to allow a customer to be informed of what he or she is purchasing.

In an exemplary embodiment, the proposed state analysis may be generated as an empty slate (i.e. starting from scratch) without any information regarding the devices possessed by the specific customer. For example, the specific customer may not possess any devices at all within a particular office since the specific customer may have just opened such particular office (i.e. new branch office). However, the user of the terminal 101 may be an experienced salesman who has encountered similar situations before and, therefore, can make proper recommendations. Thus, when generating the proposed state analysis, the devices are selected based on what the user believes is best suited (i.e. most practical) to the specific customer.

In another exemplary embodiment, the proposed state analysis may be generated based on a current state analysis. In other words, the user may select an existing current state analysis and generate an initial proposed state analysis from the selected current state analysis. Thus, the initial proposed state analysis includes all of the devices in the selected current state analysis. It should be noted that when performing this action, the proposed state analysis is an initial proposed state analysis because the user can add devices to, modify devices in and remove devices from the initial proposed state analysis. After the user is satisfied with the changes made (if any), then the fleet analysis module 101a-1 can generate the final version of the proposed state analysis.

The fleet adjustment user interface 101a-2 facilitates the selection of devices from an existing current state analysis and/or a registered proposed state analysis to be placed in a new proposed state analysis. In addition, the fleet adjustment user interface 101a-2 also facilitates adding devices to, modifying devices in, and removing devices from a proposed state analysis. For example, the user may have previously created and registered a first proposed state analysis for a particular customer. Such first proposed state analysis may include (a) new devices and (b) devices from the current state analysis corresponding to the particular customer. However, the particular customer may not be completely satisfied with the first proposed state analysis and decides that he or she wants to revise the first proposed state analysis with his or her own recommendations which may include (i) adding devices from the current state analysis that were not previously in the first proposed state analysis and (ii) removing devices that were not in the current state analysis but were newly added in the first proposed state analysis. Thus, when creating a second proposed state analysis, the fleet adjustment user interface 101a-2 allows the user to select devices from the current state analysis and the first proposed state analysis.

The server 102 may be used to access information regarding customer device models and contracts data which are stored in the customer devices database 103 and contracts data database 104, respectively.

The customer devices database 103 may include information regarding a fleet of devices (e.g., printer, MFP, scanner, facsimile machine, etc.) for each customer. In other words, each customer may have an office, at a certain geographical location (e.g., city, town, etc.), that may include a fleet of devices. Information regarding each of the devices in the fleet of devices, such as name or identifier (e.g., device name, walkthrough ID, Asset tag, etc.), device type (e.g., printer, MFP, scanner, etc.), device functions (e.g., black & white, duplex, fax, scanning, N-up, etc.), physical location, network address (e.g., IP address, MAC address, etc.), output technology (e.g., laser, inkjet solid ink, thermal, other technology, etc.), supply level (e.g., level of consumable, such as paper and toner, is empty, low, ok, etc.), pages per job (e.g., 1, 2, 6-10, etc.), color technology (e.g., professional color, convenience color, etc.), device properties (e.g., manufacturer, model, serial number, etc.), etc. are stored in the customer devices database 103.

In another example, the customer device information in the customer devices database 103 may in the form of a spreadsheet (e.g., Excel). In other words, the user may request from the customer information on the fleet of devices currently possessed by the customer by having the customer fill out an electronic spreadsheet with data (e.g., identifier, device type, functions, color technology, etc.) corresponding to each device. Such spreadsheet may be sent to the user electronically (e.g., e-mail), after which, the spreadsheet is stored in the customer devices database 103.

The state analysis database 104 registers any type of state analyses previously created by the user. In other words, the state analysis database 104 may include current state analyses corresponding to one or more customers and/or previously created proposed analyses. It should be noted that the database does not necessarily link a proposed state analysis for a particular customer. In other words, a proposed state analysis may be created in future anticipation of a type of customer. For example, the company that the user works for may have a specific proposed state analysis which includes one or more recently created products (to be used together) that are designed for companies in the information technology (IT) industry. However, the company employing the user may not yet have any customers from the IT industry. As a result, there is no company linked with the specific proposed state analysis. When the fleet analysis module 101a-1 receives instructions to create a proposed state analysis, the fleet analysis module 101a-1 may request access to the state analysis database 104 from the server 102 for the purpose of obtaining an existing current/proposed state analysis.

Therefore the user may access the server 102 to obtain previously registered current/proposed state analyses and information regarding customer devices without having to manually input the information, thereby making it more convenient for the use. The server 102 is further described infra with reference to FIG. 2.

The network 107 can be a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 106. In addition, the network 106 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

FIG. 1B schematically shows a system 100B, according to another exemplary embodiment. The system 100B is similar to the system 100A of FIG. 1A except that the application 101a on the terminal 101 additionally includes a state analysis request part 101a-3 and a comparison selection part 101a-4.

The state analysis request part 101a-3 permits a user to compare one state analysis with another state analysis. Such comparison may be facilitated by calculating the difference between the two state analyses in one or more categories (i.e. TCO, resource consumption, waste generation, etc.). After the calculations are performed, the results are displayed to the user. In one exemplary embodiment, a side-by-side comparison of the state analyses is visually shown to the user via graphs and charts (e.g., bar chart with each state analysis in a different color bar). In another exemplary embodiment, the side-by-side comparison may include a table of categories with the differences being shown in a format including letters and numbers. It should be noted that the user is not limited to comparing only two state analyses. They user can perform a comparison between three or more state analyses. In one exemplary embodiment, the user can perform a comparison between a current analysis and a registered proposed state analysis. In another exemplary embodiment, the user can perform a comparison between two current analyses. In yet another exemplary embodiment, the user can perform a comparison between a current state analysis, a registered proposed state analysis and a proposed state analysis that is currently being created.

The comparison selection part 101a-4 permits the user to select a subset of an existing current state analysis and perform a side-by-side comparison with that subset. In other words, a subset may be a portion of the devices in the existing current state analysis. The devices may be grouped in the existing current state analysis based on geography (e.g., building, floor, site, campus, etc.) or a unit (e.g., department, business unit, workgroup, cost center, etc.). Thus, the user can select a subset of the existing current state analysis and compare such subset with another current state analysis, a registered proposed state analysis or a newly created proposed state analysis that has not yet been registered.

Otherwise, operations of the elements of the system 100B are similar to those discussed in connection with the corresponding elements of the system 100A of FIG. 1A.

FIG. 1C shows schematically a system 100C, according to another exemplary embodiment. The system 100C is similar to the system 100A of FIG. 1A except that the device management application 101a in the terminal 101 additionally includes a multiple proposal part 101a-5.

The multiple proposal part 101a-5 permits the automatic creation of a proposed state analysis based on a certain category (e.g., mono/color, geographical location, contractual terms, device type, etc.) in the device information. In other words, there may be one or more set categories that a user may select when the user is attempting to create a proposed state analysis from a current state analysis. When the user selects such category, the multiple proposal part 101a-5 extracts all the devices in the current state analysis that correspond to that category and creates a proposed state analysis. For example, the user may wish to create a proposed state analysis based on devices that only print in color. Thus, the multiple proposal part 101a-5 extracts the color printing devices from the current state analysis and generates a proposed state analysis with only those extracted devices.

In an exemplary embodiment, the user can also request an extended state analysis in which the devices in the extended state analysis are the same as the ones in the current state analysis. The difference between the extended state analysis and the current state analysis is that the contractual price may be different. In other words, for example, a particular customer may be a café chain which has multiple locations within a city. Since the needs of the cafés may not be that different from each other, the devices requested for each one may be the same. Thus, the company employing the user may extend contracts for each café newly opened by the particular customer and may plan to give a proposed state analysis to the customer corresponding to that newly opened café. In such case, the proposed state analysis may be the same as the current state analysis (i.e. current devices owned by the other existing cafés). However, in recognition of customer loyalty, the company employing the user may offer a discount in which the contract price that was in the current state analysis is reduced by an amount in the proposed state analysis.

The multiple proposal part 101a-5 may also replace devices based on the selection of category made by the user. For example, the user may request the multiple proposal part 101a-5 to create a replace mono state analysis in which only mono devices (i.e. devices that only print in black and white) in the current state analysis are to be replaced by newer models. In another example, the user may request the multiple proposal part 101a-5 to create a replace mono and color state analysis in which both mono and color devices in the current state analysis are to be replaced by newer models.

It should be noted that when an extended state analysis, a replace mono state analysis, or a replace mono and color state analysis are performed, the devices to be replaced and/or extracted do not necessarily have to be from the current state analysis. Instead, the devices can be replaced/extracted from the proposed state analysis.

FIG. 2 shows an exemplary constitution of a computing device that can be configured (for example, through software) to operate (at least in part) as a server (e.g., 102 in FIGS. 1A-1C). In FIG. 2, apparatus 200 includes a processor (or central processing unit) 202 that communicates with a number of other components, including memory or storage device 203, input/output (e.g., keyboard, mouse, etc.) 204, display 205 and network interface 206, by way of a system bus 201. The apparatus 200 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as should be appreciated by those skilled in the relevant art. In the apparatus 200, the processor 202 executes program code instructions that control device operations. The processor 202, memory/storage 203, input/output 204, display 205 and network interface 206 are conventional, and therefore in order to avoid obfuscating the inventive aspects of this disclosure, such conventional aspects are not discussed in detail herein.

The apparatus 200 includes the network interface 206 for communications through a network, such as communications through the network 107. However, it should be appreciated that the subject matter of this disclosure is not limited to such configuration. For example, the apparatus 200 may communicate with user terminals through direct connections and/or through a network to which some components are not connected. As another example, the apparatus 200 does not need to be provided by a server that services terminals, but rather may communicate with the devices on a peer basis, or in another fashion.

The apparatus 200 of the present disclosure is not limited to a server or computer, but can be manifested in any of various devices that can be configured to communicate over a network and/or the Internet.

An exemplary constitution of the client device 101 of FIG. 1 is shown schematically in FIG. 3. In FIG. 3, terminal 300 includes a processor (or central processing unit) 302 that communicates with various other components, such as memory (and/or other storage device) 303, display 304, application software 305, input/output (such as keyboard, mouse, touchpad, stylus, microphone and/or speaker with voice/speech interface and/or recognition software, etc.) 306 and network interface 307, by way of an internal bus 301.

The memory 303 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 307 provides a connection (for example, by way of an Ethernet connection or other network connection which supports any desired network protocol such as, but not limited to TCP/IP, IPX, IPX/SPX, NetBEUI, etc.) to the network to which the computer 300 is connected (e.g., network 107 of FIG. 1).

Additional aspects or components of the computer 300 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

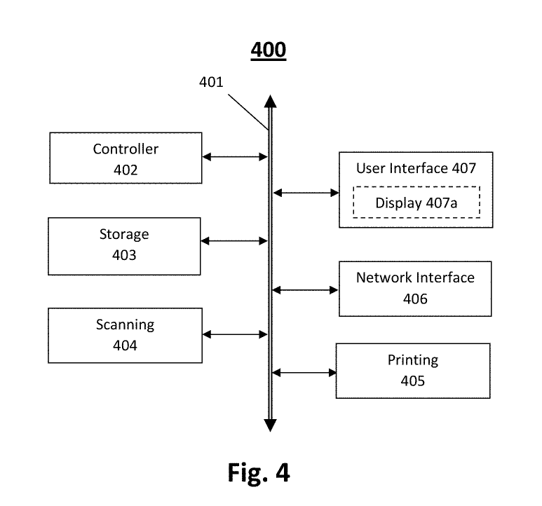

FIG. 4 shows a schematic diagram of a configuration of an output device 400 as an MFP (multi-function printer or multi-function peripheral) device. The output device 400 shown in FIG. 4 includes a controller 402, and various elements connected to the controller 402 by an internal bus 401. The controller 402 controls and monitors operations of the output device 400. The elements connected to the controller 402 include storage 403 (for example, random access memory, read-only memory, hard disk drive, portable storage media drive such as for optical discs, magnetic discs, magneto optical discs, etc., semiconductor memory cards, combinations of storage media, etc.), scanning 404, printing 405, a network interface (I/F) 406, a user interface 407.

Storage 403 can include one or more storage parts or devices [e.g., a read only memory (for example, ROM, PROM, EPROM, EEPROM, etc.), a random access memory (RAM), a hard disk drive (HDD), portable media (for example, floppy disk, optical disc, magnetic discs, magneto-optical discs, semiconductor memory cards, etc.) drives], and program code instructions can be stored in one or more parts or devices of storage 403 and executed by the controller 402 to carry out the instructions. Such instructions can include instructions for performing specified functions (such as printing, scanning, faxing, copying, e-mailing, etc.) of the output device 400, to enable the output device 400 to interact with a terminal, as well as perhaps other external devices, through the network interface 407, and interactions with users through the user interface 407.

The network interface 406 is utilized by the output device 400 to communicate via a network with other network-connected devices such as a terminal, a server and receive data requests, print (or other) jobs, user interfaces, and etc.

The user interface 407 includes one or more electronic visual displays that display, under control of controller 402, information allowing the user of the output device 400 to interact with the output device 400. The electronic visual display can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the output device 400, so as to allow the operator to interact conveniently with services provided on the output device 400, or with the output device 400 serving as terminal for accessing electronic data or other content through the network. User interfaces or other contents received through the network via the network interface 406 can be displayed on the display screen.

The display screen does not need to be integral with, or embedded in, a housing of the output device 400, but may simply be coupled to the output device 400 by either a wire or a wireless connection. The user interface 408 may include keys and/or buttons (such as graphical keys or buttons, or other graphical elements, of a GUI on a touchscreen display 407a) for inputting information or requesting various operations. Alternatively, the user interface 407 and the display screen may be operated by a keyboard, a mouse, a remote control, voice recognition, or eye-5 movement tracking, or a combination thereof.

Since the output device 400 is typically shared by a number of users, and is typically stationed in a common area, the output device 400 preferably prompts the user to supply login credentials or authentication information, such as user name (or other user or group information), password, access code, etc. The user credentials may be stored for the session and automatically supplied for access to other devices through the network. On the other hand, such other devices may prompt the user to supply other user credentials through the user interface. Other methods of authentication may also be used. For example, the MFD 400 may be equipped with a card reader or one or more biometrics means (such as comparing fingerprints, palm prints, voice or speech, retinas or irises, facial expressions or features, signature, etc.). The MFD 400 may communicate the user credentials, provided in the manners discussed above, to other devices or applications connected to the MFD 400 via a network (e.g., the network 107 of FIGS. 1A-1C) for determining authorization for performing jobs.

Scanning 404, printing 405, and network interface 406 are otherwise conventional, and therefore, a detailed description of such conventional aspects is omitted in the interest of clarity and brevity. The output device 400 can have any or all of the functions of similar devices conventionally known, such as for scanning, editing and storing images, sending a fax, sending and receiving e-mails with or without attachments, accessing files by FTP or another protocol or facility, surfing the Web, scan-to-folder, scan-to-email, etc. Further, multi-functional devices or multi-function peripheral devices can play a prominent role to convert hardcopy documents to electronic documents.

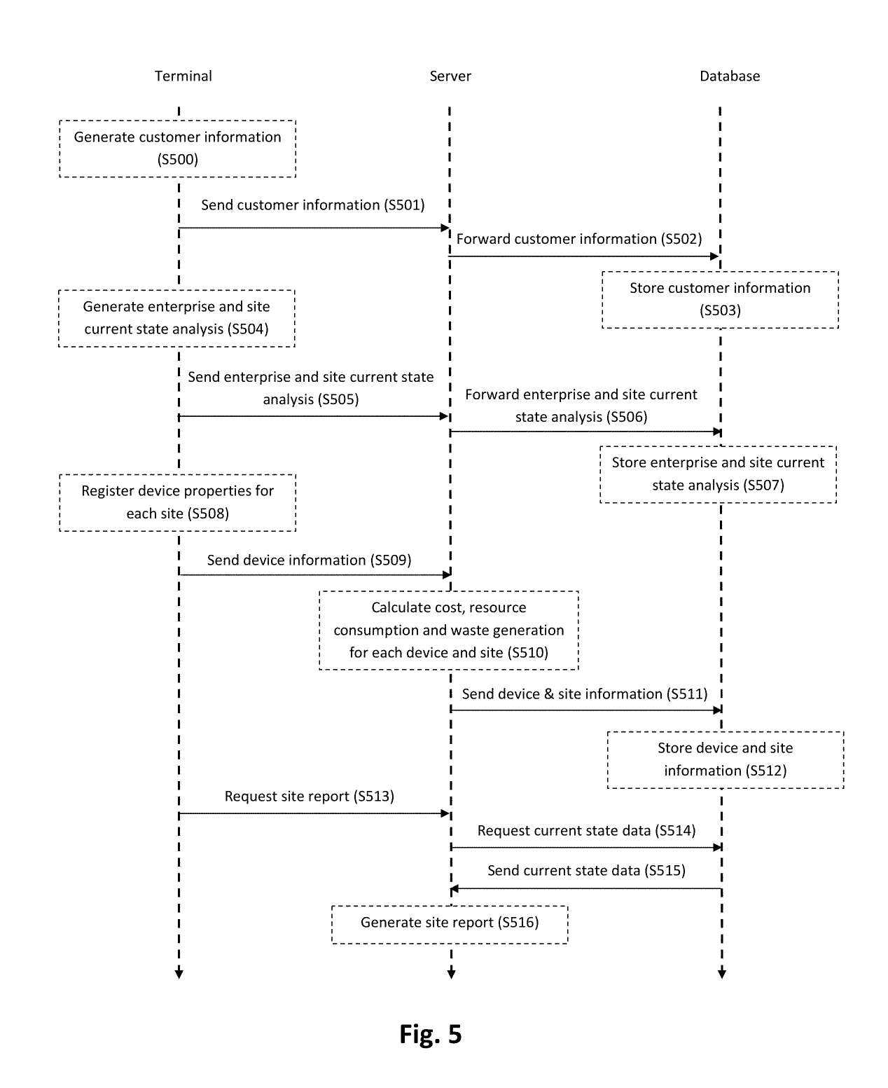

FIG. 5 graphically shows communication flow in any of the systems shown in FIGS. 1A-1C, according to an exemplary embodiment.

When a terminal generates customer information received from a user (S500), the terminal sends such customer information to a server (S501). The server then proceeds to the forward the customer information to the database (S502) where the customer information is stored (S503). Likewise, when the terminal generates an enterprise and site current state analysis (S504), the terminal sends such enterprise and site current state analysis to a server (S505). The server then proceeds to the forward the enterprise and site current state analysis to the database (S506) where the enterprise and site current state analysis is stored (S507). Next, the terminal register device properties for each site (S508) and sends the device properties to the server (S509). In response, the server calculates the cost (e.g., purchasing, renting, servicing, etc.), resource consumption (e.g., ink, paper, electricity, etc.) and waste generation (e.g., carbon dioxide) for each device and site as device and site information (S510). Next, the server sends the device and site information to the database (S511) where it is stored (S512). When the terminal sends a request for a site report (S513), the server requests the database for current state data which may include the device and site information previously stored (S514). In response, the database sends the server the current state data (S515). After receiving the current state data, the server generates a site report (S516).

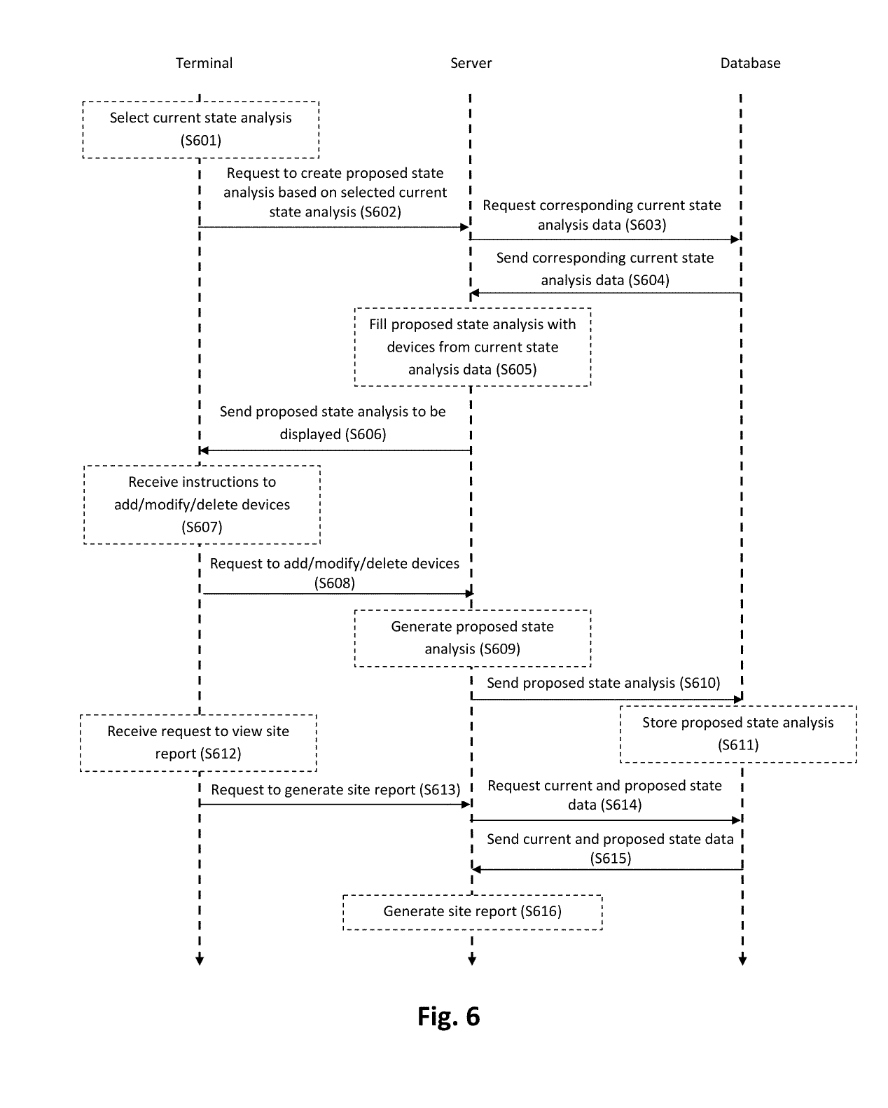

FIG. 6 shows a method that can be performed in, for example, any of the systems illustrated in FIGS. 1A-1C, according to an exemplary embodiment.

After a user selects a current state analysis (S601), the terminal requests the server to request to create proposed state analysis based on selected current state analysis (S602). Next, the server requests corresponding current state analysis data from the database (S603). In response, the server sends corresponding current state analysis data (S604). The server than proceeds to fill the proposed state analysis with devices from current state analysis data (S605) and sends the proposed state analysis to be displayed on the terminal (S606). In response, the terminal may receive instructions to add/modify/delete devices (S607) and therefore may send a request to add/modify/delete devices (S608). In response, the server generates the proposed state analysis (S609) and sends the proposed state analysis to the database (S610) where it is stored (S611). When the terminal receives an instruction to display a site report (S612), the terminal sends a request for a site report (S613), the server requests the database for current and proposed state data which may include the current and proposed state analysis previously stored (S614). In response, the database sends the server the current and proposed state data (S615). After receiving the current and proposed state data, the server generates a site report (S616).

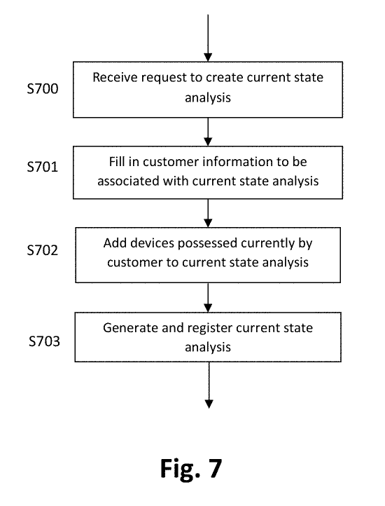

FIG. 7 show a method that can be performed by or with a device fleet analysis application (e.g., 101a) on a terminal apparatus (e.g., 101), according to an exemplary embodiment.

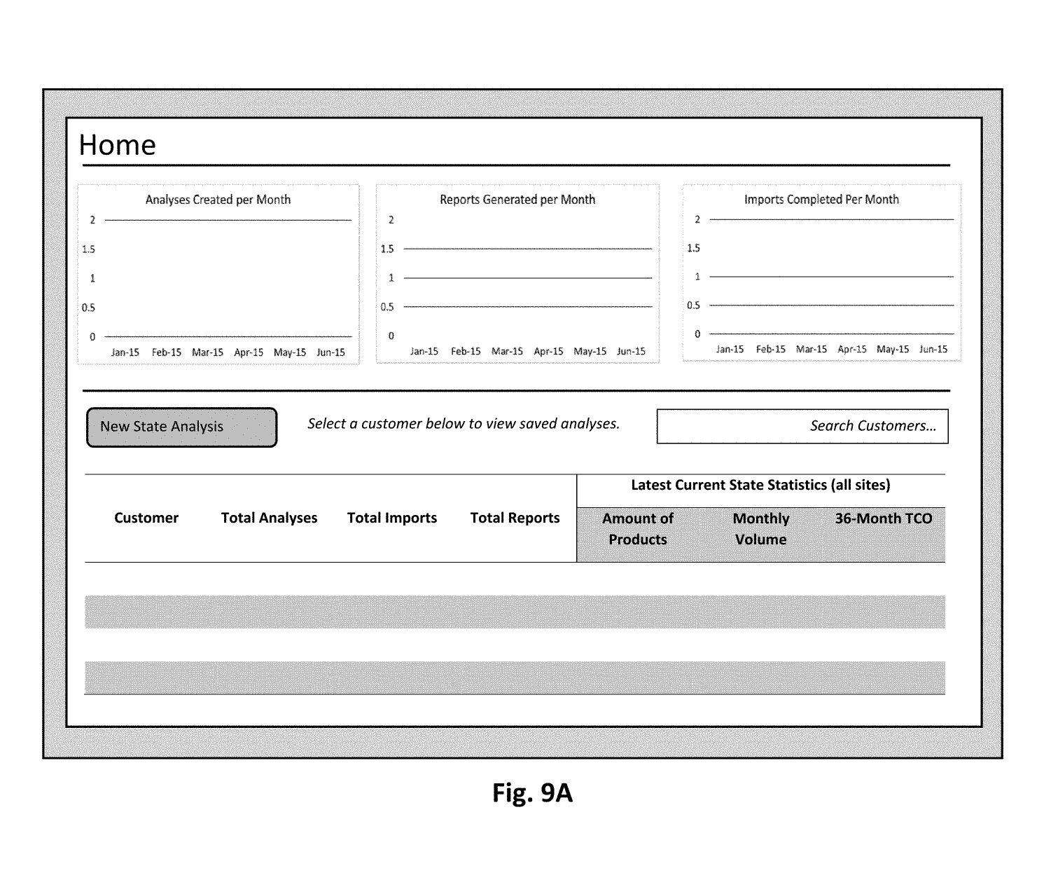

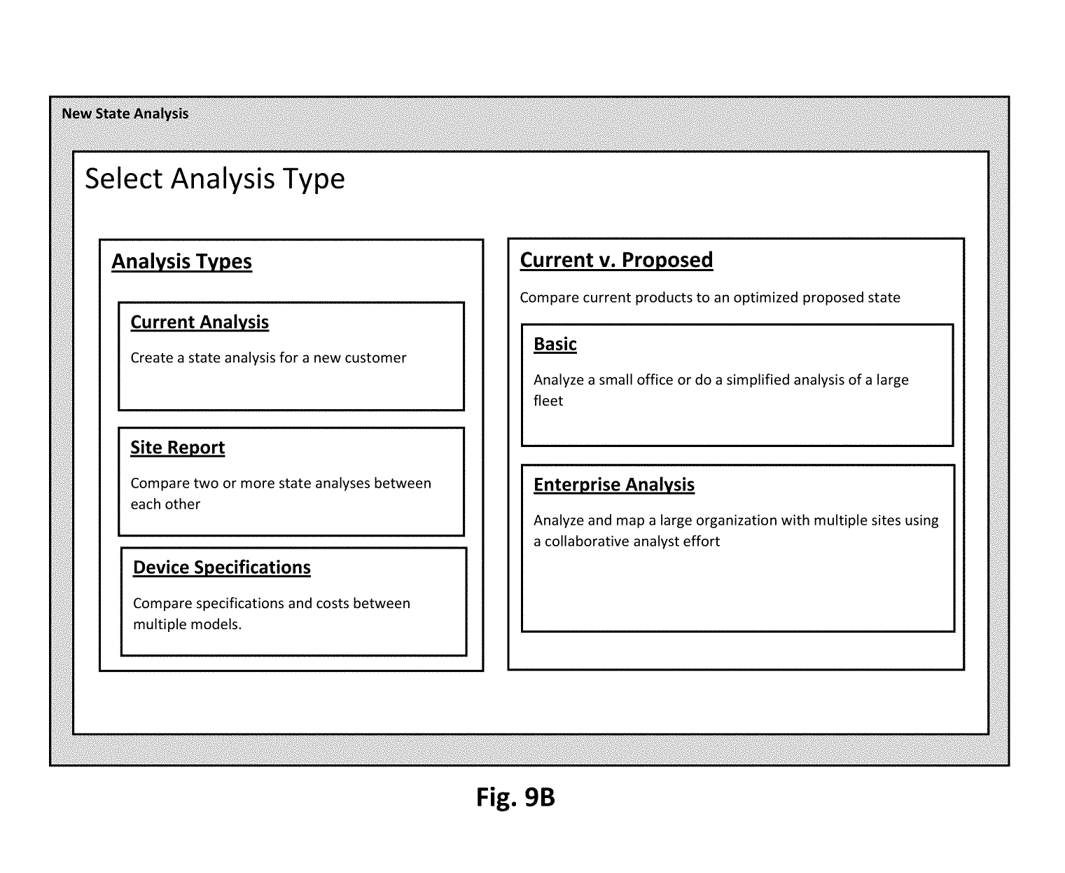

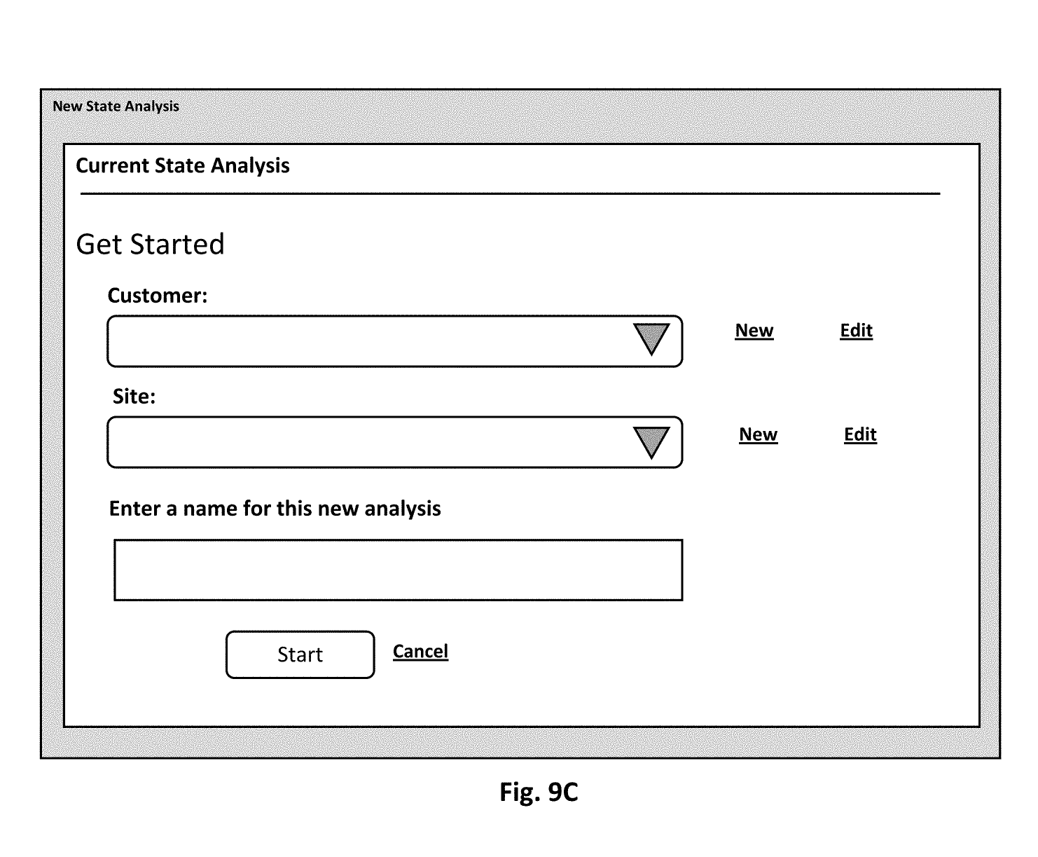

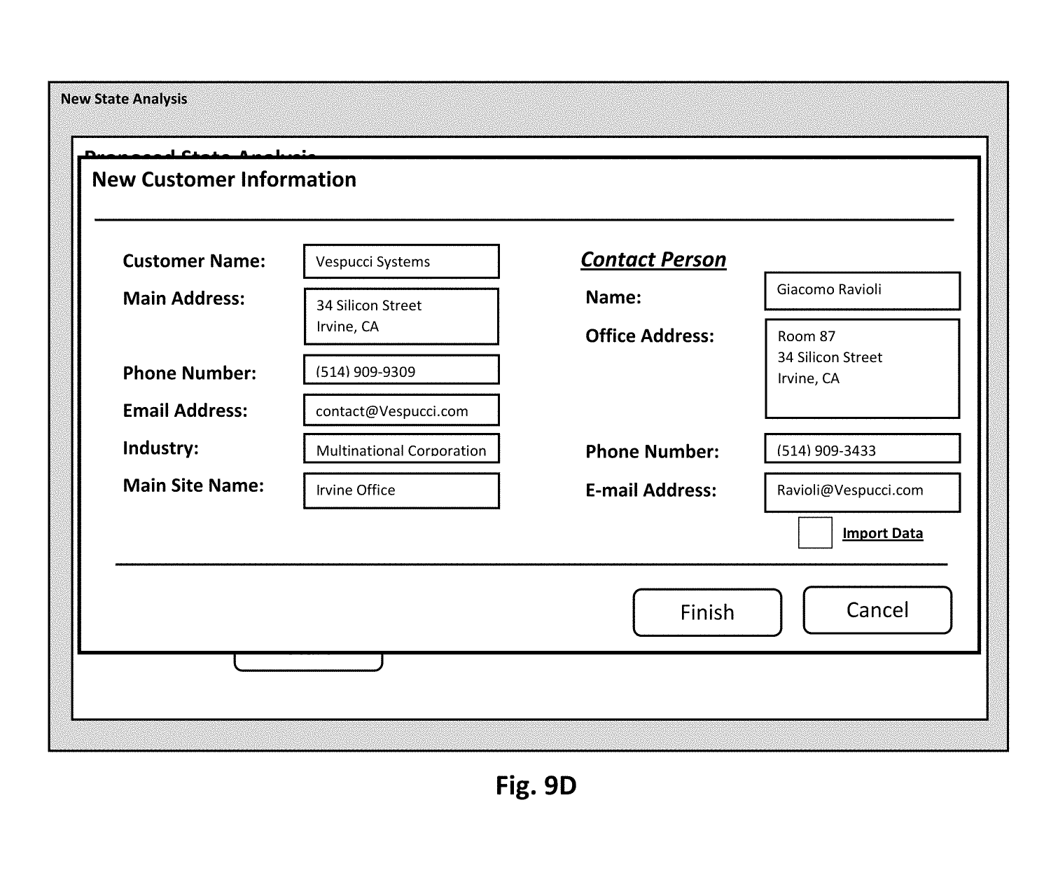

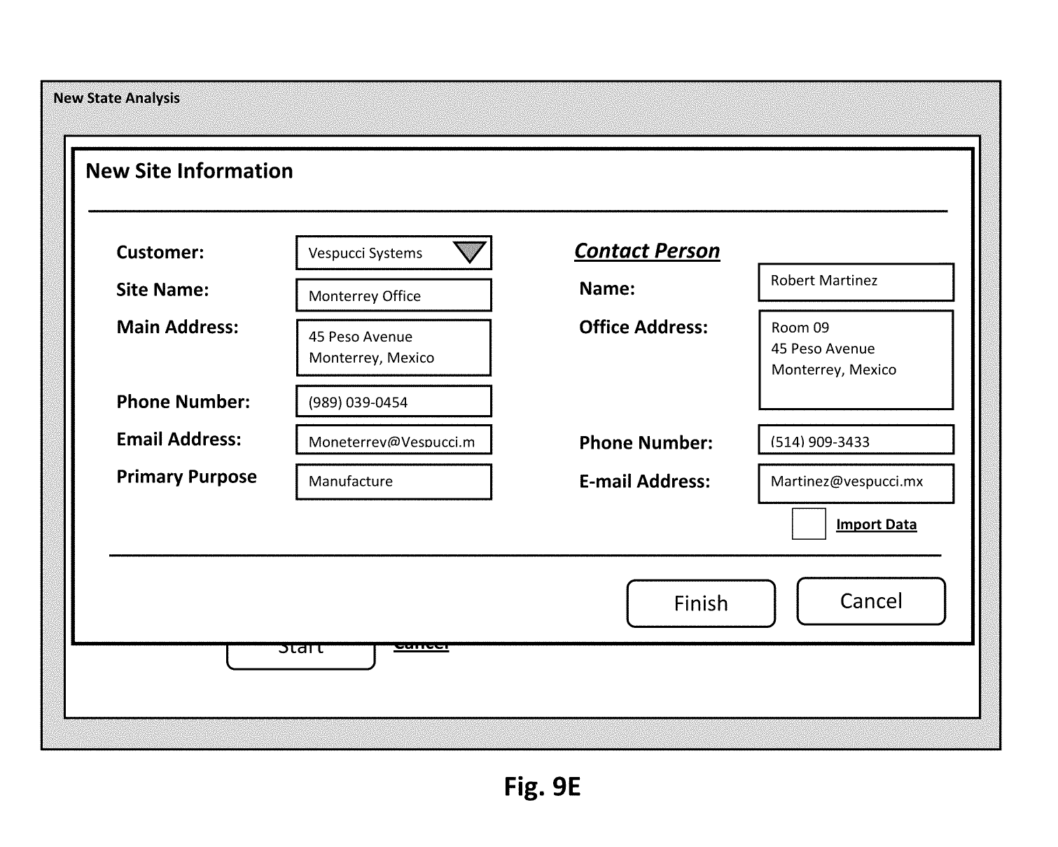

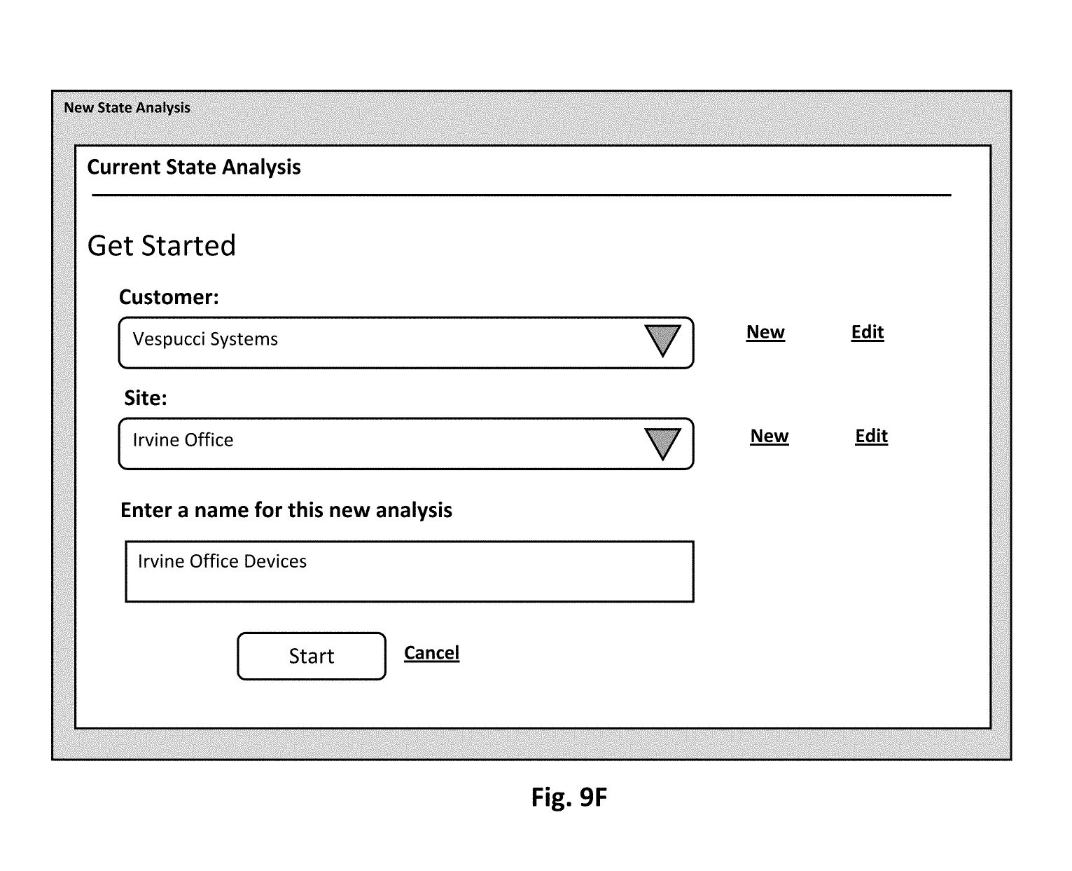

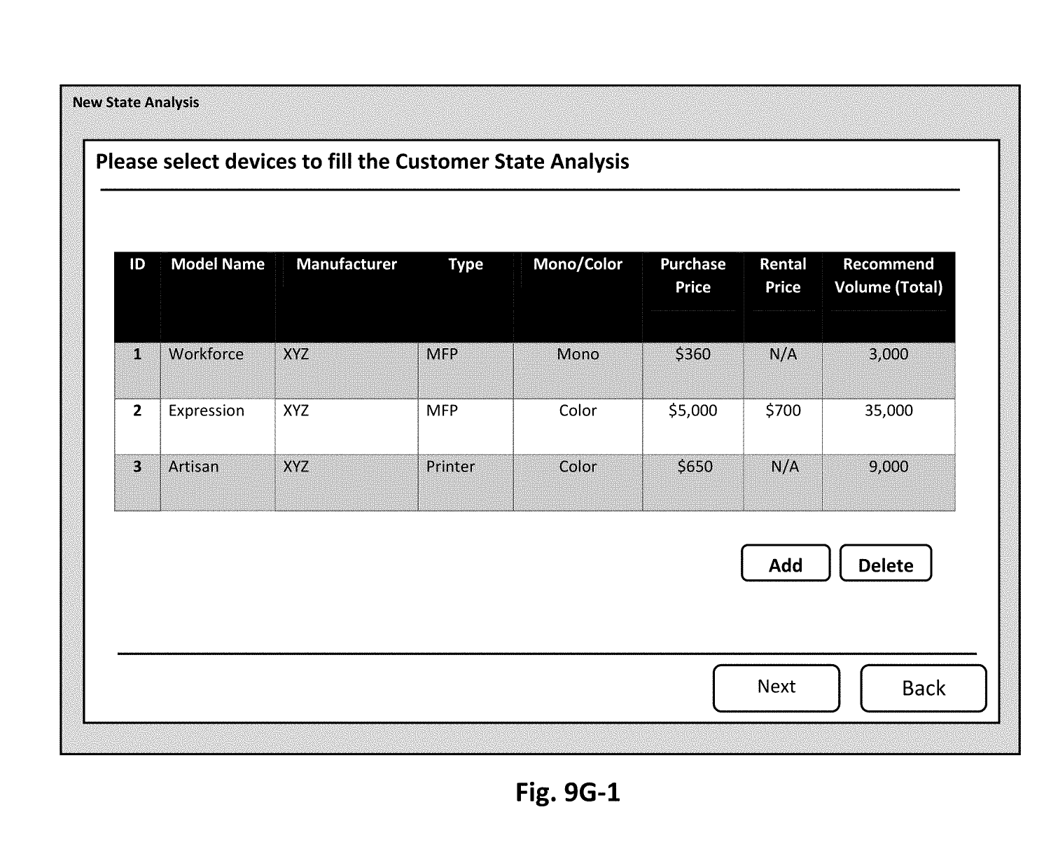

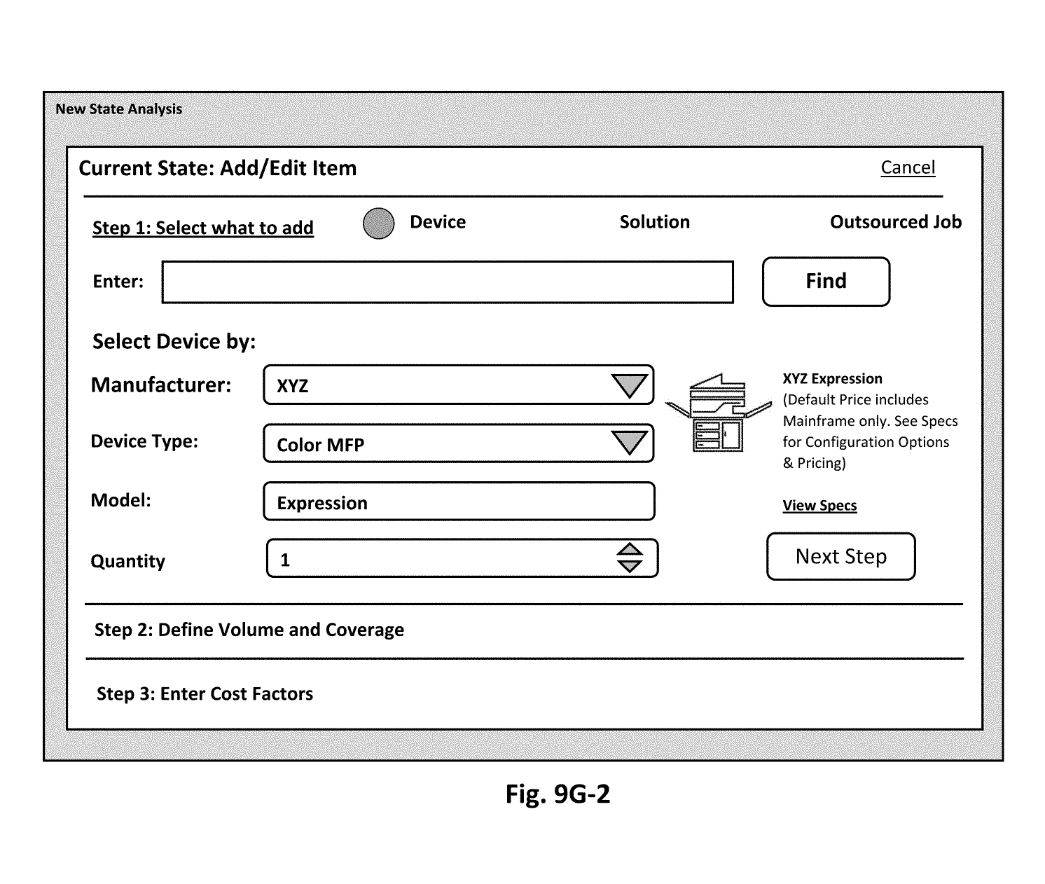

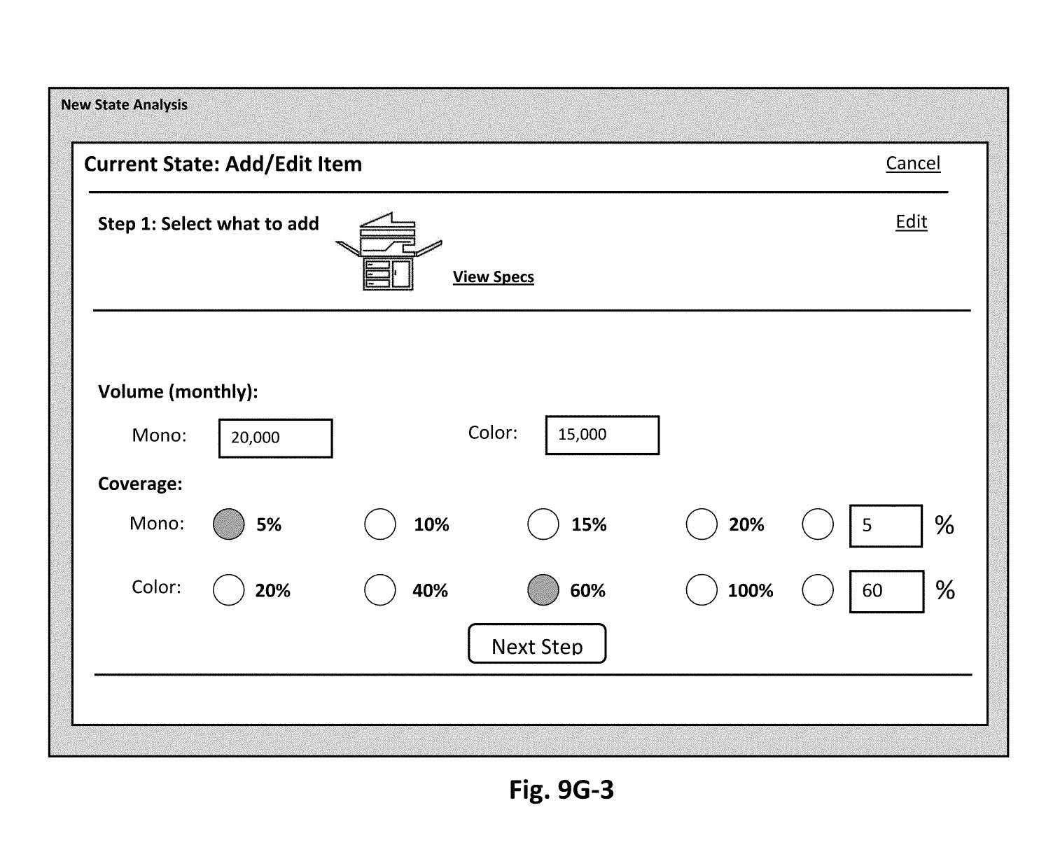

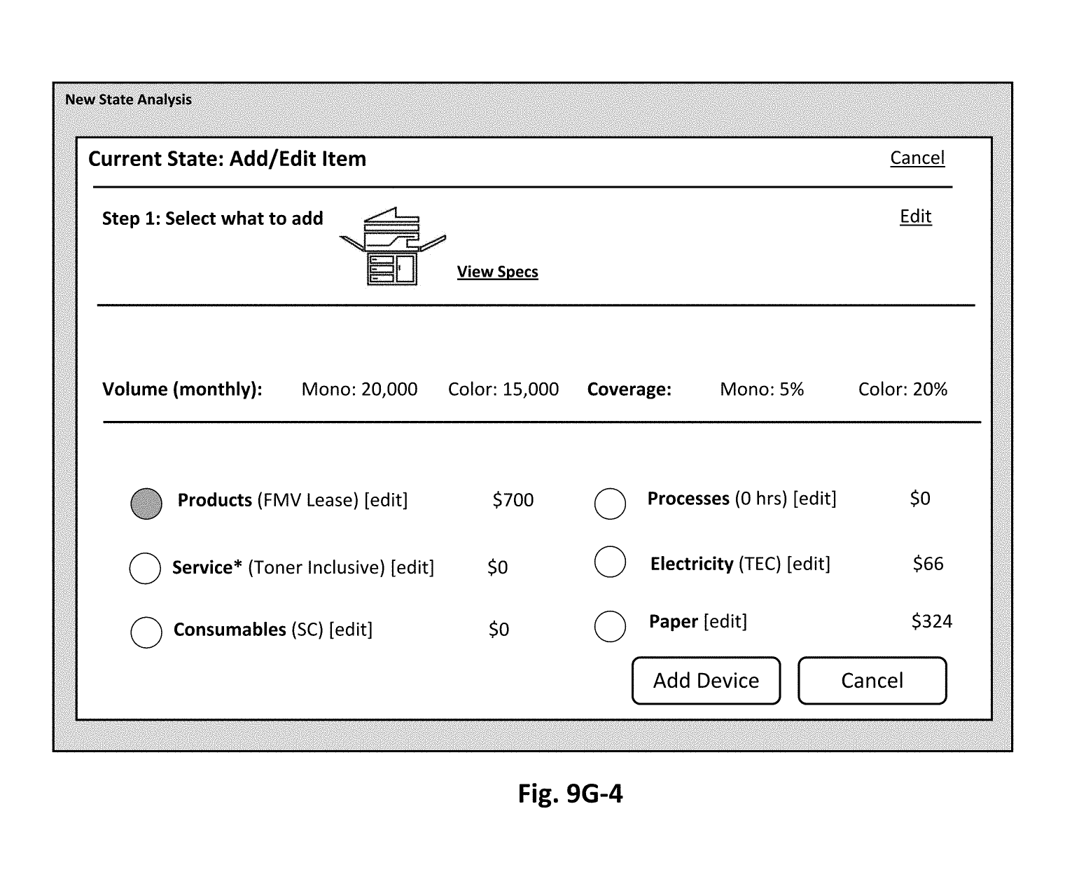

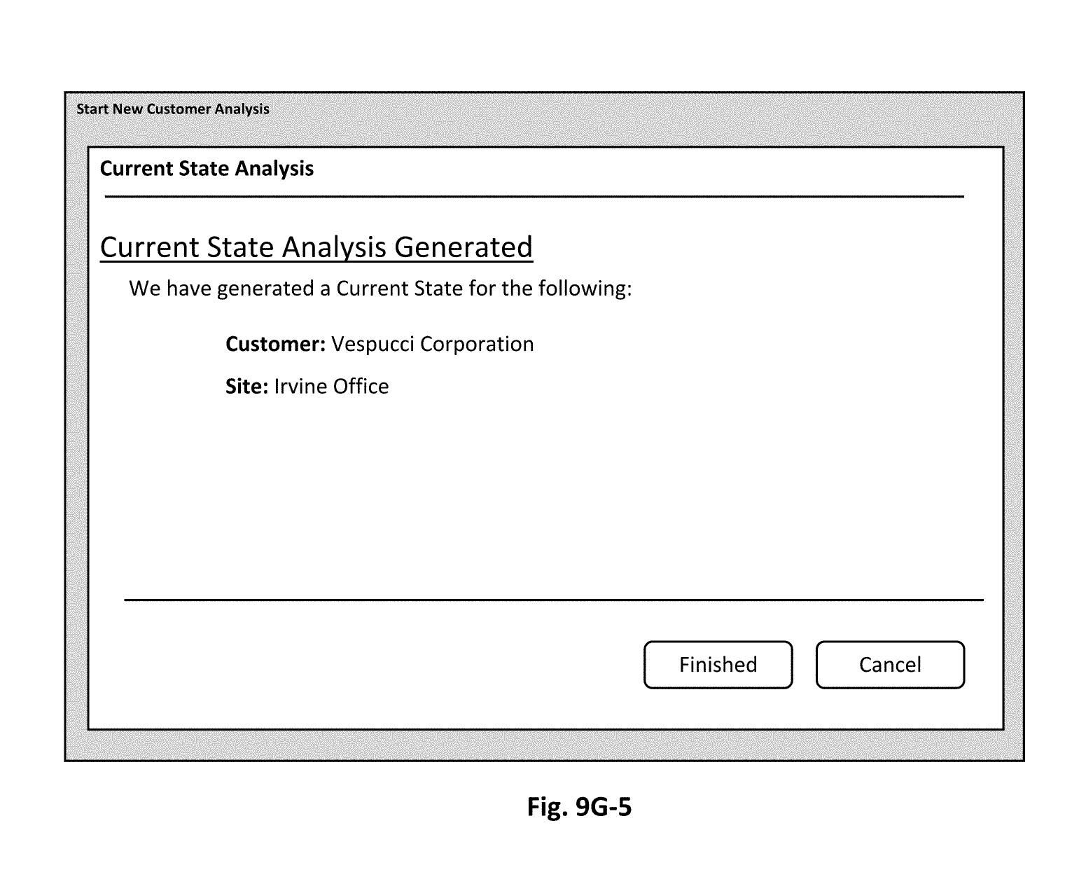

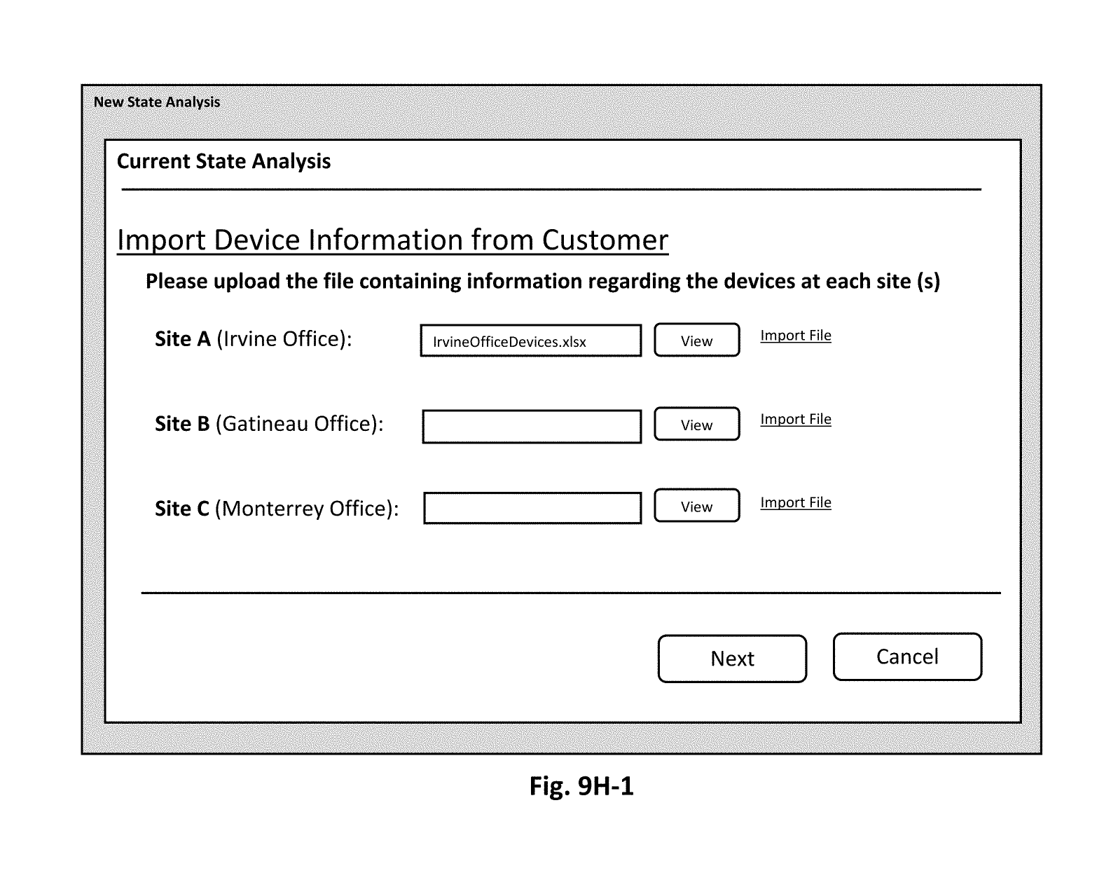

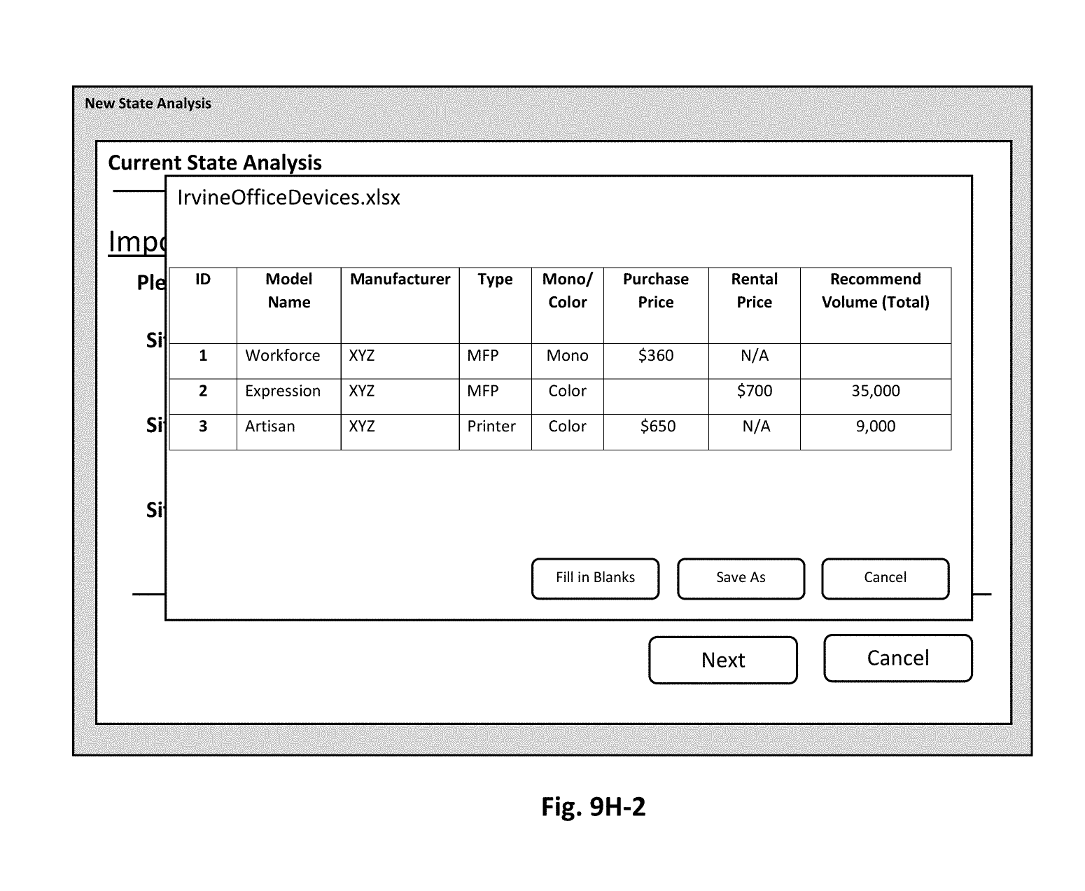

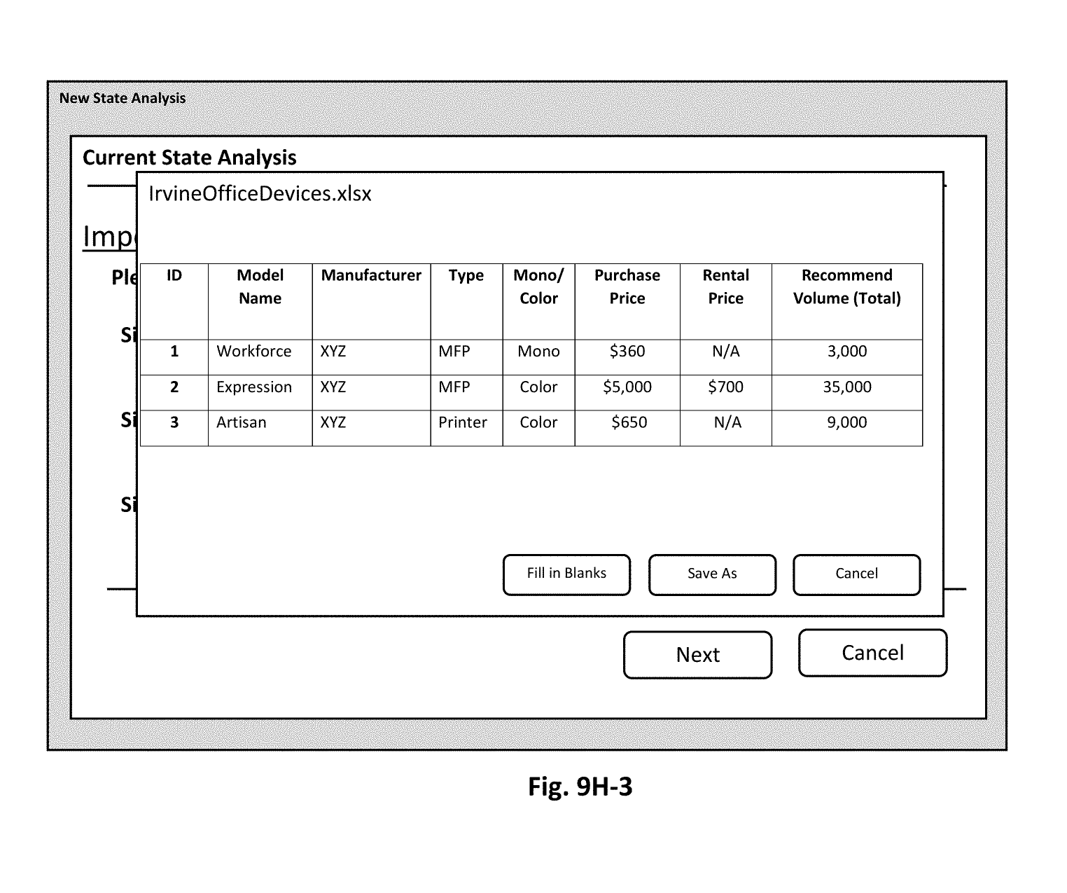

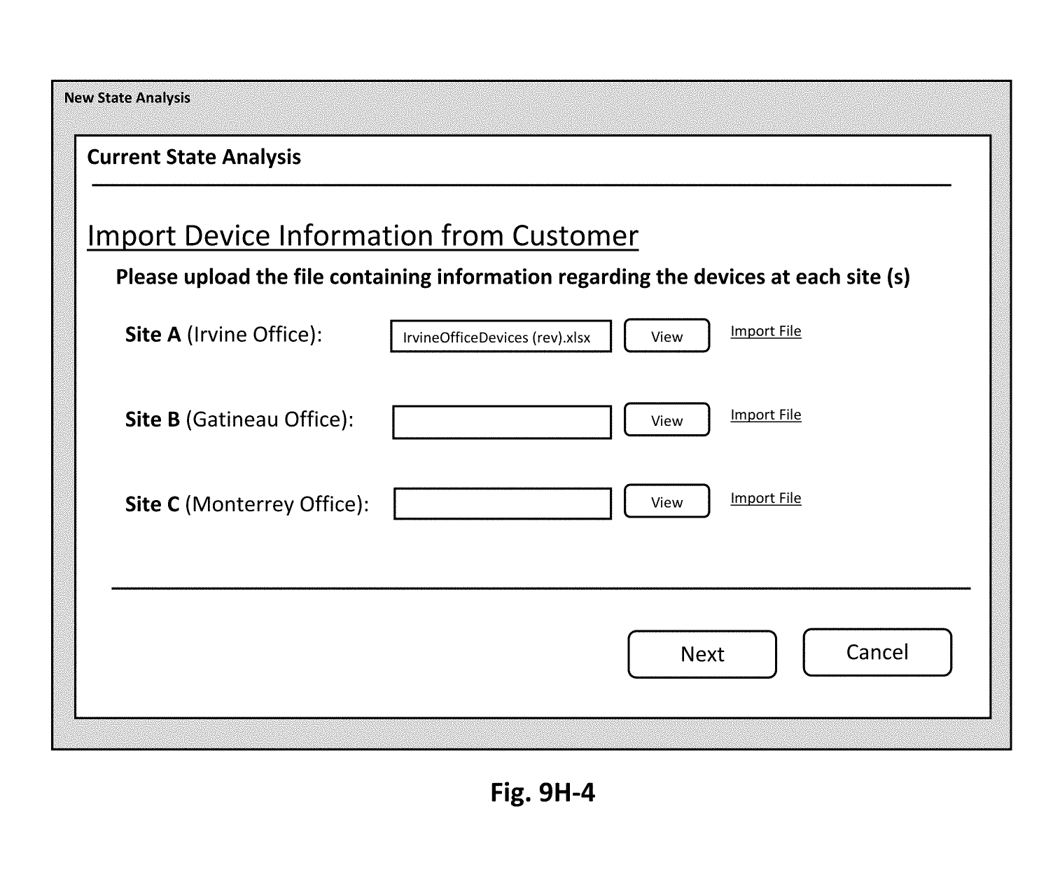

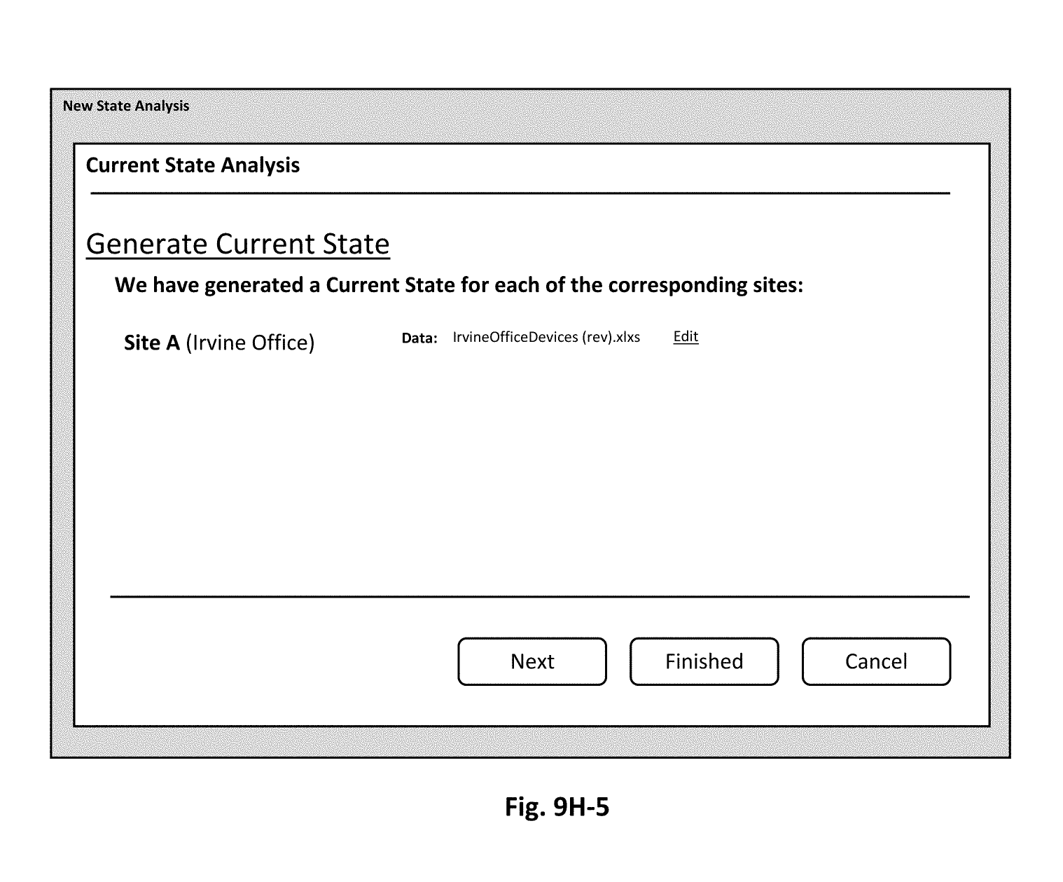

In an example of a workflow discussed below with reference to FIG. 9A through FIG. 9H-5 a user (e.g. “Harold”) may be a salesman working at “Ricoh Corporation” and has responsibilities such as advising potential (or existing) customers what device models manufactured by Ricoh would be suitable for them. An information technology (IT) manager (“Giacomo Ravioli”) at “Vespucci Systems”, is looking to replace devices manufactured by “XYZ Technologies” which recently became defunct due to bankruptcy. Because devices manufactured by Ricoh having a household name, Giacomo determines that Ricoh may offer the best devices in terms of quality and, therefore, decides to contact (e.g., telephone, email, etc.) a salesperson at Ricoh to negotiate purchasing of one or more devices. Such person who happens to answer the communication by Giacomo is the user Harold.

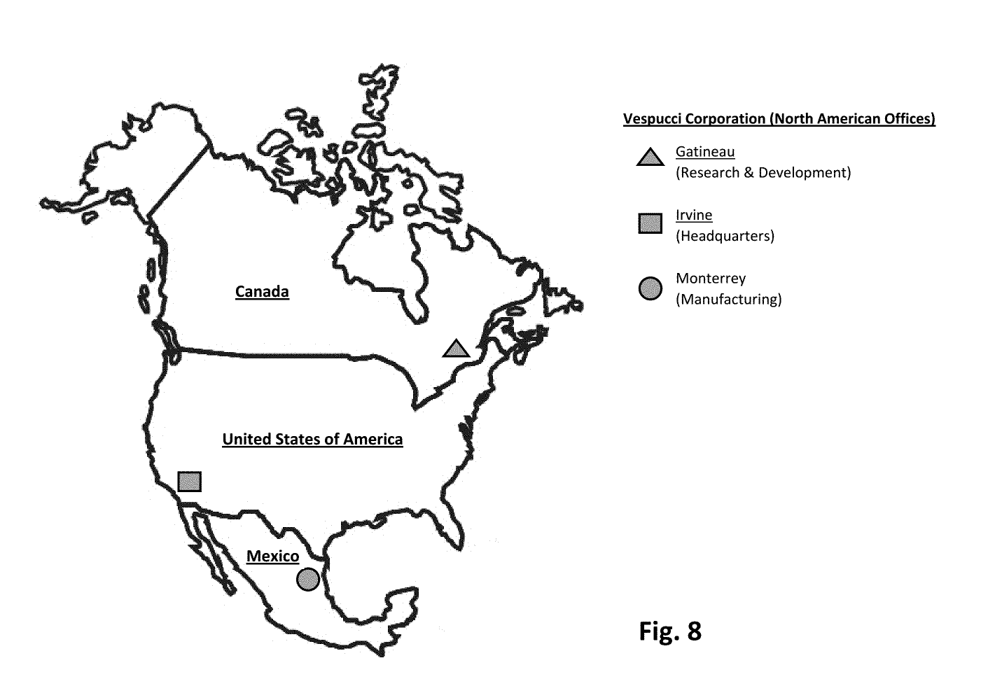

Giacomo explains to the user Harold that Vespucci currently operates in North America and has offices located in Irvine, Calif., United States, Gatineau, Quebec, Canada, and Monterrey, Nuevo Leon, Mexico, such as shown in FIG. 8. However, Giacomo also tells the user Harold that he currently only wants to replace the devices within the Irvine Office and therefore requests a proposal of devices that would be suitable for this. In response, the user Harold sends a spreadsheet to Giacomo and asks him to fill out the spreadsheet with data on devices currently existing the Irvine Office.

A short while later, the user Harold may receive an e-mail from Giacomo which contains the completed spreadsheet that includes all of the information regarding the devices in the Irvine Office of Vespucci. With this information at hand, the user Harold can now start creating a profile for the Irvine Office of Vespucci. The user Harold commences this action by activating the “New State Analysis” button (S700), such as shown in FIG. 9A. Next, since the user Harold is doing a current state analysis for a Vespucci, he activates the “Current Analysis” button, such as shown in FIG. 9B.

Afterwards, Harold is shown a screen for getting started, such as shown in FIG. 9C. Since the Vespucci is a new customer, it has not yet been entered into an existing customer list. Thus, the user Harold may add a new customer by activating the “New” button which causes a screen for entering new customer information to be presented to the user Harold (S701), such as shown in FIG. 9D. It should be noted that when entering new customer information, the fields (e.g., address, phone number, email address, etc.) may correspond to a “main site” of the new customer. In other words, it is usually the case that a customer is located in at least one specific location. Thus, when the user enters contact information (e.g., address, phone number, email address, etc.) into the fields, such contact information usually should respond to that at least one specific location. Thus, the at least one specific location becomes one of the “sites” of the customer. For example, in this case, the “Main Site” is called Irvine Office. After entering the relevant customer information, the user Harold activates the “Finished” button which causes the Vespucci to be added to the customer list.

Next, the user Harold can create sites for the Gatineau Office and Monterrey Office by activating the “New” button corresponding to the “Site” category which causes a screen for entering new site information to be presented to the user Harold, such as shown in FIG. 9E. As can be seen, the user Harold enters information in fields that are similar to the fields shown previously in the screen illustrated in FIG. 9D. After entering the relevant customer information, the user Harold activates the “Finished” button which causes the new site to be added to the sites that correspond to Vespucci. After entering in the Vespucci profile, the user Harold selects the customer (i.e. Vespucci) and site (i.e. Irvine Office) information from the drop down menu and activates the “Start” button, such as shown in FIG. 9F. After the user Harold has activated the “Start” button, he can begin adding devices to the current state analysis corresponding to Vespucci (S702).

In one exemplary embodiment, the user Harold is presented with an empty table in which he can add to and delete devices from by activating the “Add” and “Delete” button respectively, such as shown in FIG. 9G-1. In the case that the user Harold activates the “Add” button, he is presented with a screen, such as shown in FIG. 9G-2, to add a device by (i) searching for the device via a search box or (ii) using a series of drop-down menus to narrow down a device. The user Harold may input device information that he has obtained from the email sent by Giacomo. In on example, after the user Harold has selected a device, the user Harold can view technical specifications corresponding to the device selected by activating the “View Specs” button. In another example, the user Harold can define the quantity of the device (i.e. the customer may have many devices of the same model).

After the user Harold is satisfied with his selection, he may activate a first “Next Step” button which allows the user Harold to enter volume and coverage of the device to be added, such as shown in FIG. 9G-3. Next, the user Harold may activate a second “Next Step” button to enter cost factors (e.g., products, electricity consumption, service, etc.), such as shown in FIG. 9G-4. The reason why the user Harold may need to enter such information (e.g., volume, coverage, electricity consumption, etc.) is because it is possible that when Giacomo purchased the devices on behalf of Vespucci, some of the devices were customized specifically for Vespucci. Thus, such customized devices would have different specifications from the standard devices of the same model. After the user Harold has finished inputting all of the devices corresponding to the email received from Giacomo, the user Harold can activate the “Next” button which causes the device fleet analysis application to generate a current state analysis for the site Irvine Office (S703), such as shown in FIG. 9G-5.

In another exemplary embodiment, the user Harold may not need to enter the information received from Giacomo. Instead, he can electronically upload the spreadsheet received from Giacomo. For example, the device fleet analysis application requests the user Harold to import information regarding the devices at each of the branches (i.e. “Site A”, “Site B” and “Site C”) of Vespucci, such as shown in FIG. 9H-1. Further, the user Harold may also view the file given to him by Giacomo, such as shown in FIG. 9H-2.

For example, the file including the information of each device at a certain branch (e.g., Irvine Office, Gatineau Office and Monterrey Office) may not be complete. It may be that records were destroyed or lost causing Giacomo to partially fill out the form. Such is indicated by the blank spaces in the spreadsheet shown in FIG. 9H-2. It should be noted that the identifier “N/A” does not mean that Giacomo does not know the value regarding that particular information. Instead, Giacomo understands that such value may not exist. For example, the device “Workforce” has an “N/A” under the category “Rental Price” because the device “Workforce” cannot be rented (i.e. only purchasable) and not because Giacomo doesn't know what value to put in that category.

Thus, when there is incomplete information in the table of devices, the user Harold can complete the table by activating the “Fill in Blanks” button which causes the device marketing application to communicate with a third party source (e.g., Amazon, Best Buy, Newegg, Staples, PC Richard and Son, etc.) to obtain information that can complete the table. Once the table is completed, such as shown in FIG. 9H-3, the user Harold can save the completed table by activating the “Save As” button which causes the file to be saved as “IrvineOfficeDevices(rev).xlsx”, such as shown in FIG. 9H-4. It should be noted that since the user Harold is only generating the current state analysis for the Irvine Office, the user Harold is not required to import data files for the other two sites (e.g., Gatineau Office and Monterrey Office). Thus, when the user Harold activates the “Next” button, a current state analysis is generated only for the Irvine Office, such as shown in FIG. 9H-5.

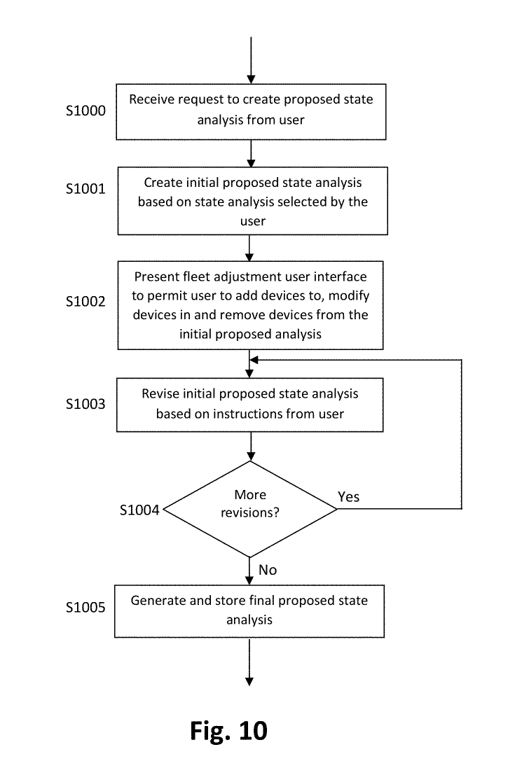

FIG. 10 show a method that can be performed by a device fleet analysis application (e.g., 101a) on a terminal apparatus (e.g., 101), according to an exemplary embodiment.

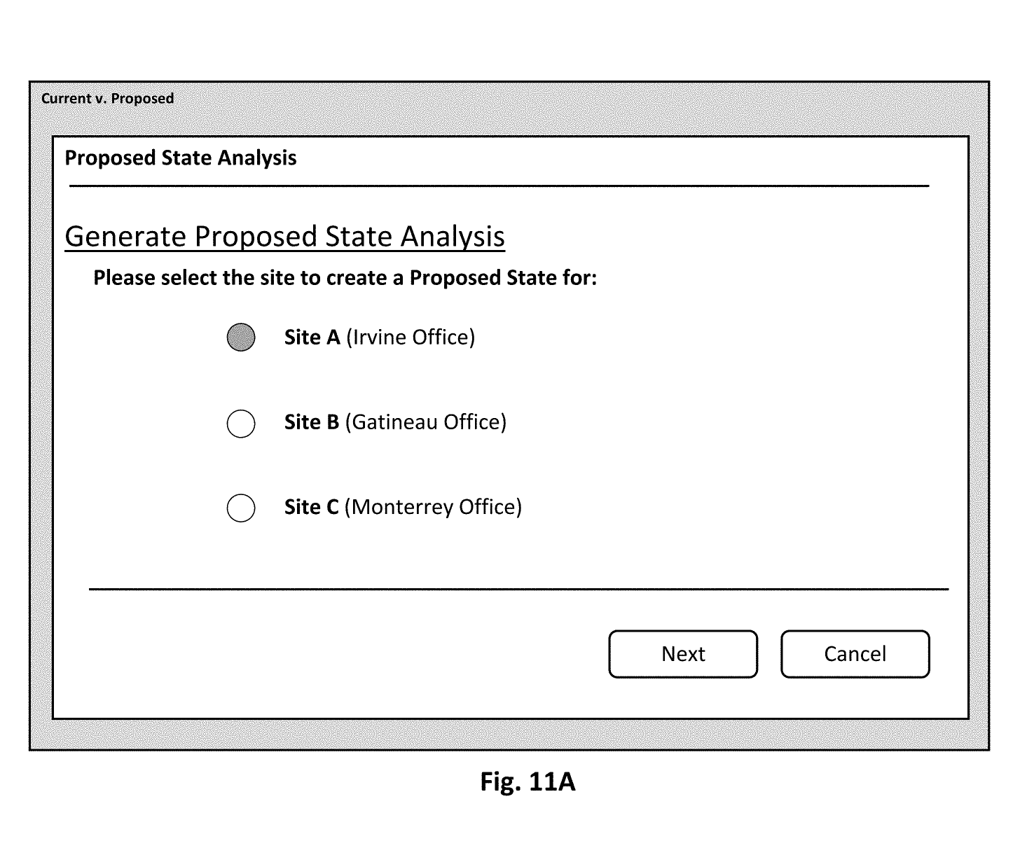

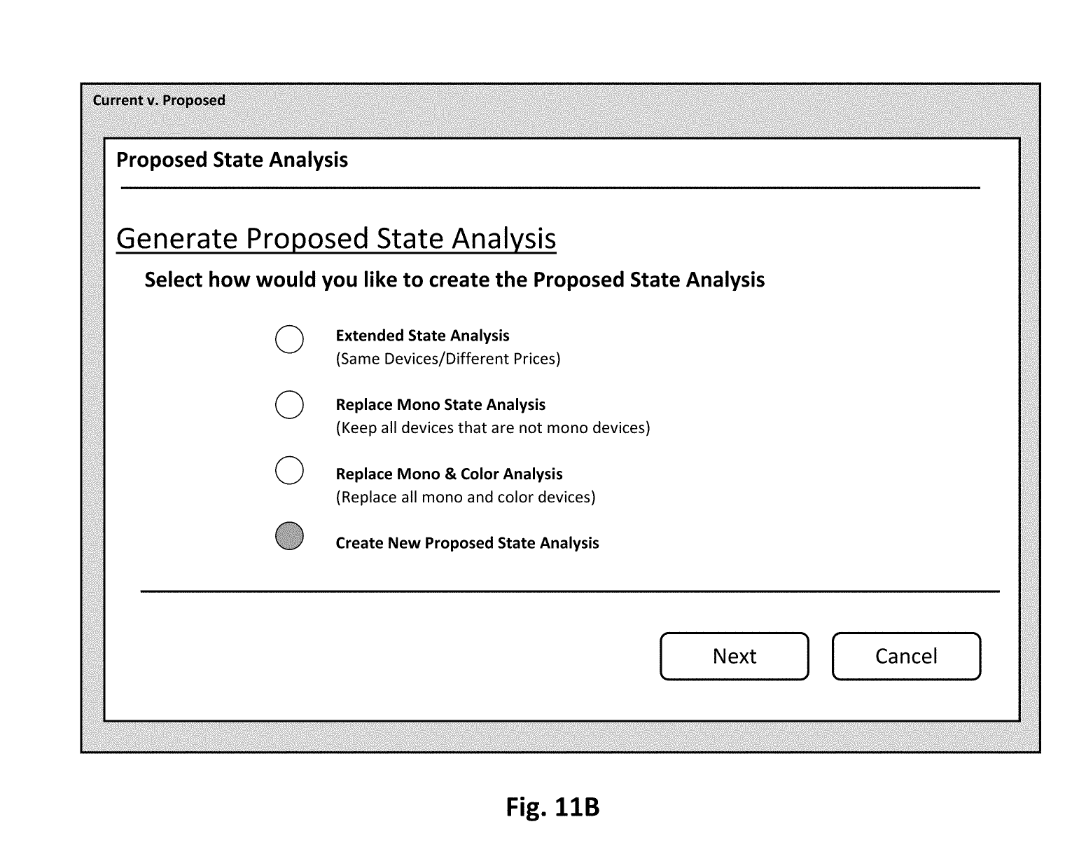

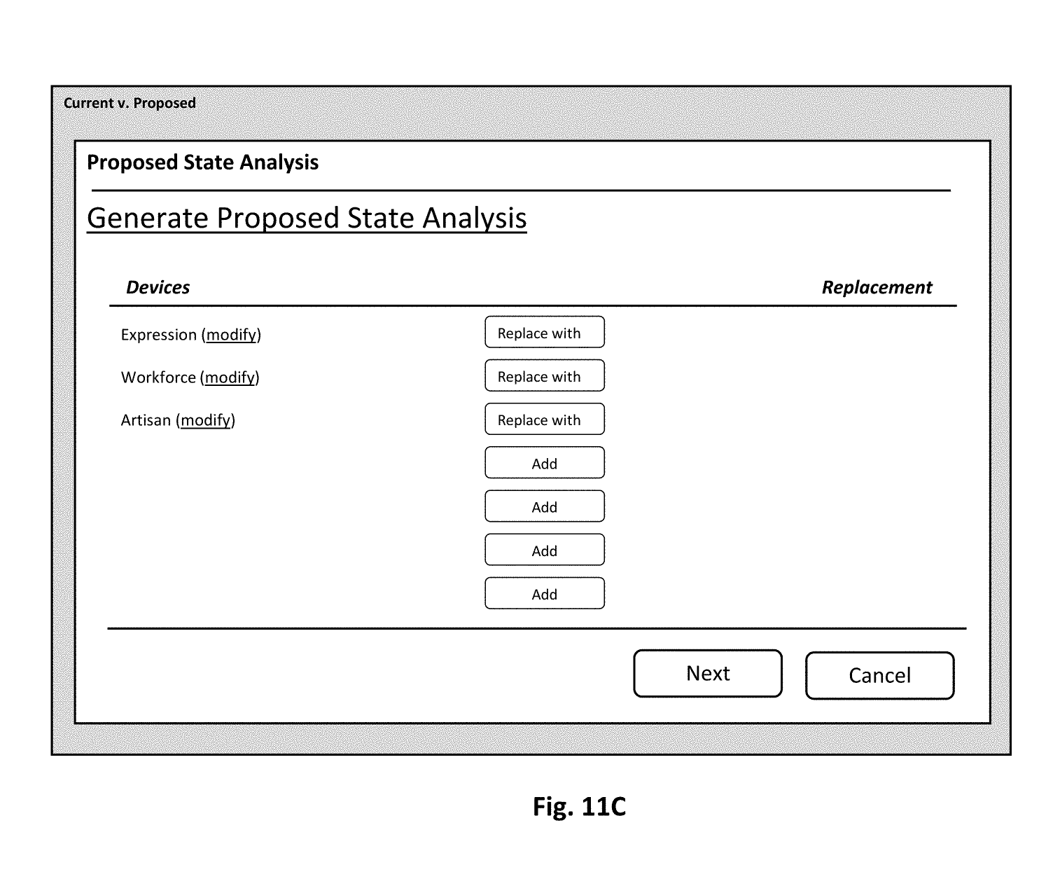

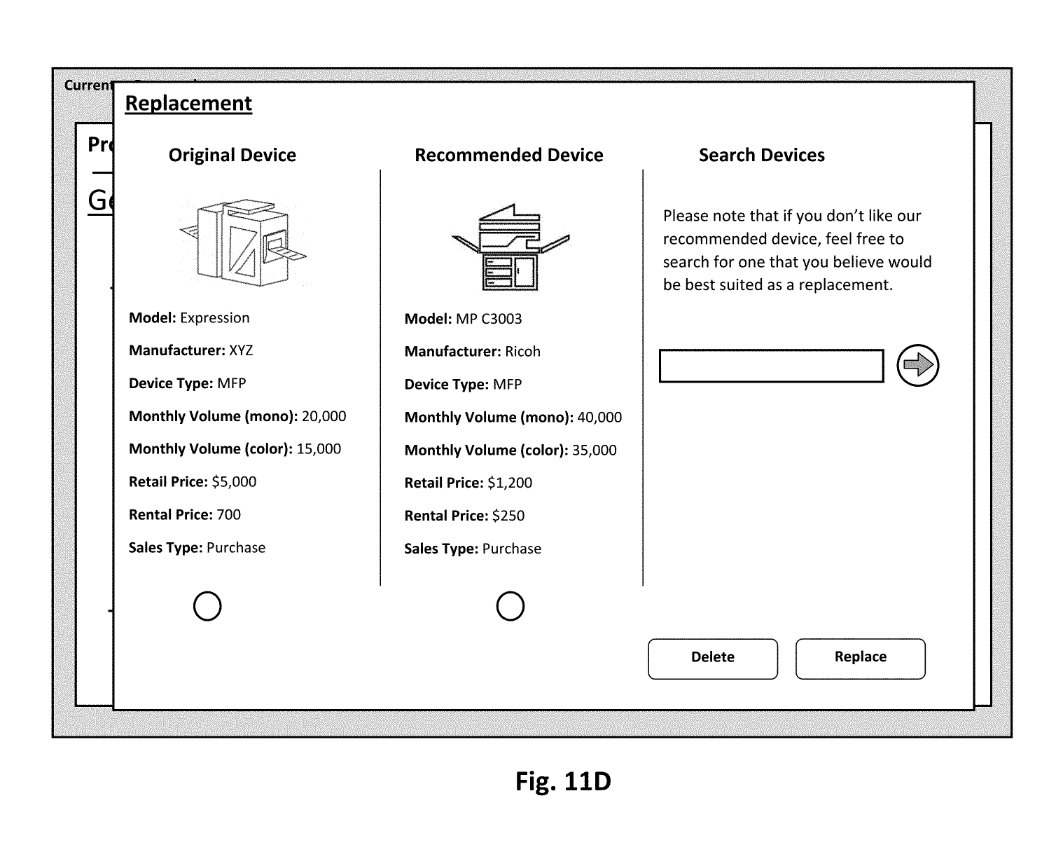

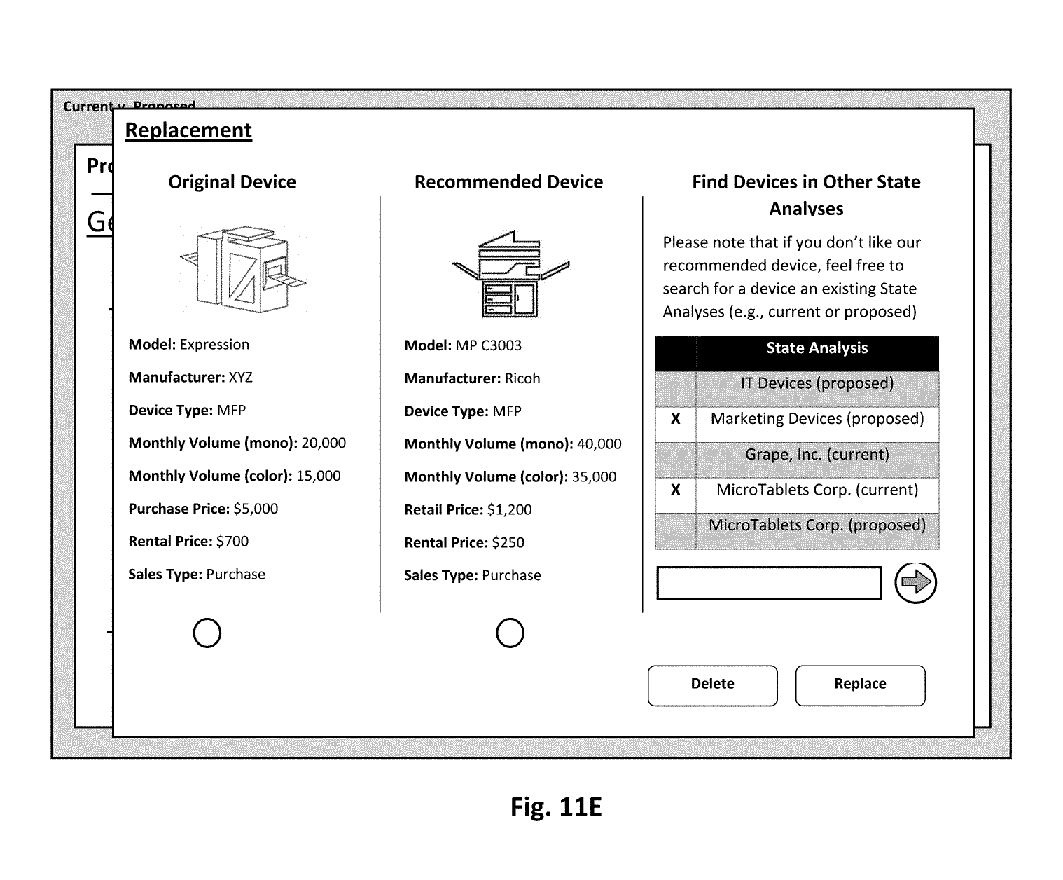

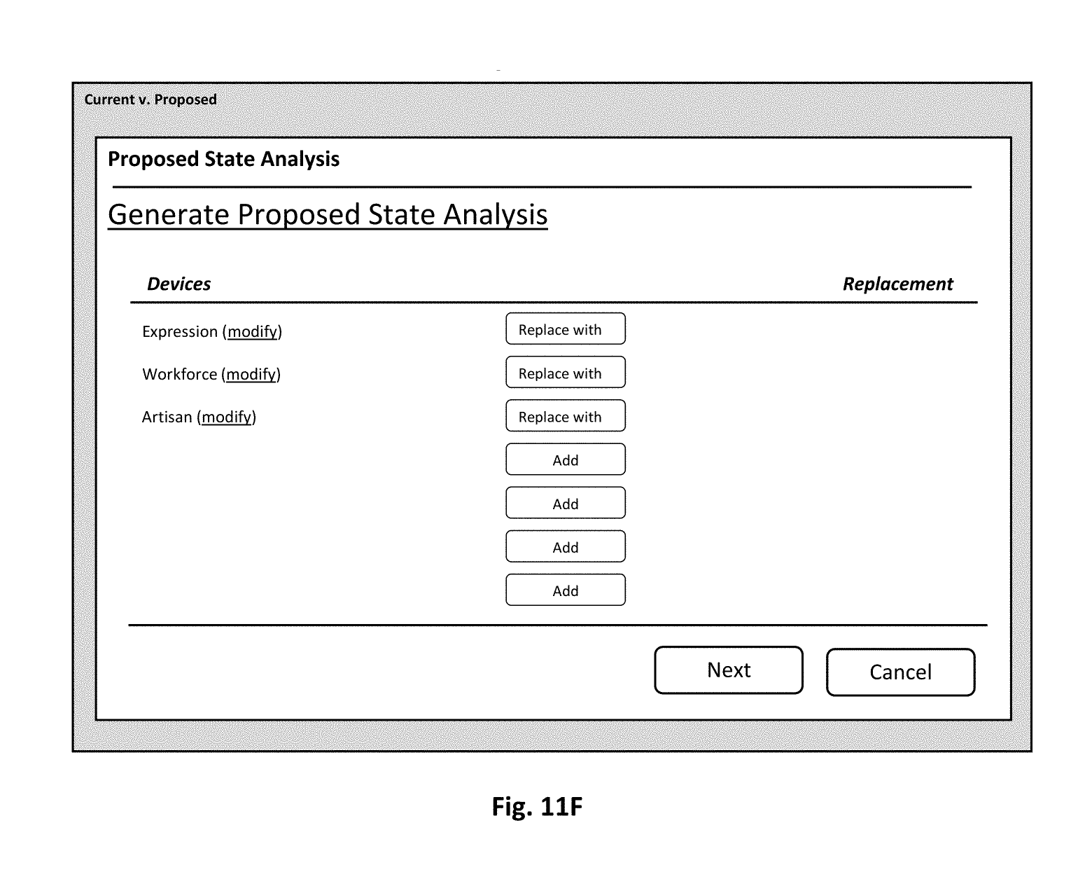

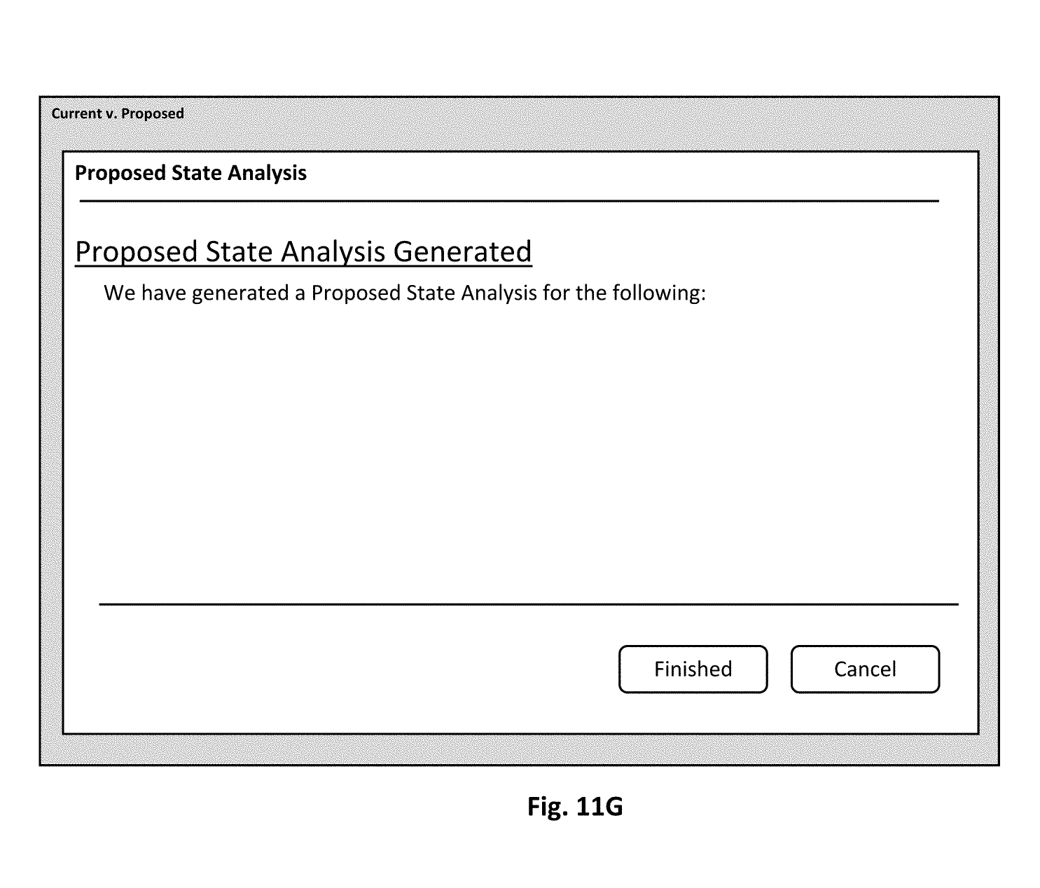

After creating the current state analysis, the user Harold can now create a proposed state analysis by activating the “Basic” button (S1000) as previously shown in FIG. 9B. Next, the user Harold is presented with options to select a current state analysis (e.g., “Site A”, “Site B”, or “Site C”), such as shown in FIG. 11A. In this case, since Giacomo asked Harold for a proposed state analysis corresponding to the Irvine Office, the user Harold selects the “Site A” option. Next, the device fleet analysis application presents to the user Harold a screen for selecting a method to perform a proposed state analysis, such as shown in FIG. 11B. In other words, the user Harold is given many ways to create a proposed state analysis.

In one example, the user Harold may select the “Extended State Analysis” option which creates a proposed state analysis with all the current devices (assuming that all the devices in the current state analysis were sold by Ricoh Corporation to a customer) intact. The only major change would be the pricing of the entire set of devices within the proposed state analysis. In another example, the user Harold may select the “Replace Mono State Analysis”, in which the proposed state analysis keeps all devices that don't print only in mono. In yet another example, the Harold may select the “Replace Color and Mono State Analysis” in which all devices that print in Mono and Color are replaced in the proposed state analysis.

In this case, the user Harold has selected to create a new proposed state analysis. Next, the user Harold is presented with an initial proposed state analysis (S1001), such as shown in FIG. 11C. In such case, the initial proposed state analysis includes all the devices that are in the current state analysis previously selected. As a result, the user Harold can modify the existing devices via the “modify” button, replace the devices via the “Replace with” button or add new devices to the initial proposed state analysis via the “Add” button (S1002). For example, when the user Harold activates the “Replace with” button corresponding to the device “Expression”, the user Harold is presented with a screen, such as shown in FIG. 11D.

As shown, the device fleet analysis application may recommend a device that may be superior to or more efficient than the device “Expression”. Such recommendations are made automatically and have no influence from the user in any way. Further, the user Harold has several options in which he can (i) keep the current device, (ii) replace the current device with the recommendation made by the device fleet analysis application or (iii) search for a device. In an exemplary embodiment, the user Harold can also search for devices in other state analyses that have been previously registered, such as shown in FIG. 11E. In such case, the user Harold can select any state analyses (i.e. current or proposed) meaning that the user Harold can even select state analyses made for other companies or organizations. After revising the initial proposed state analysis based on the instructions from the user Harold (1003), the device fleet analysis application determines if there are more revisions (S1004). In the case that there are more revisions (S1004, yes), the process repeats. In the case that the user Harold is satisfied with his selection of devices (S1004, no), such as shown in FIG. 11F, he may activate the “Next” button which generates the proposed state analysis (S1005), such as shown in FIG. 11G.

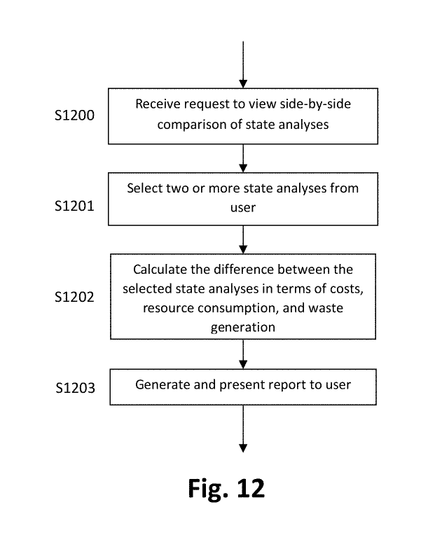

FIG. 12 show a method that can be performed by a device fleet analysis application (e.g., 101a) on a terminal apparatus (e.g., 101), according to an exemplary embodiment.

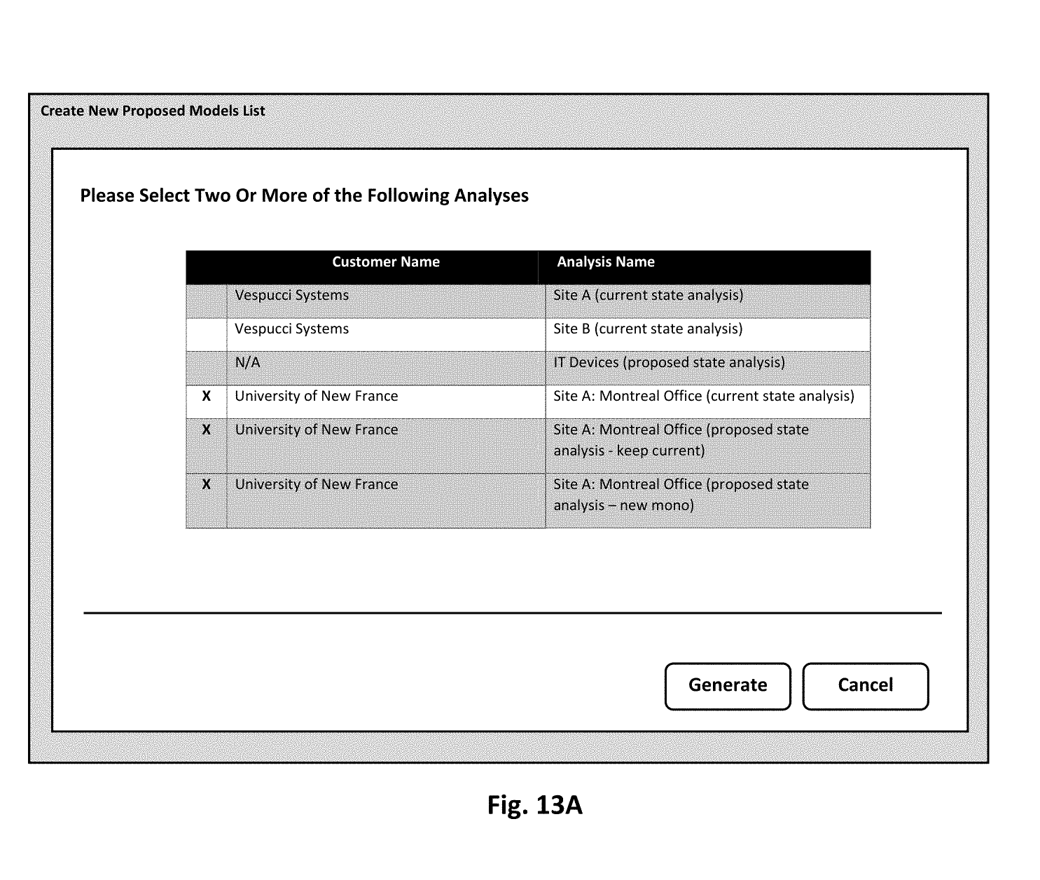

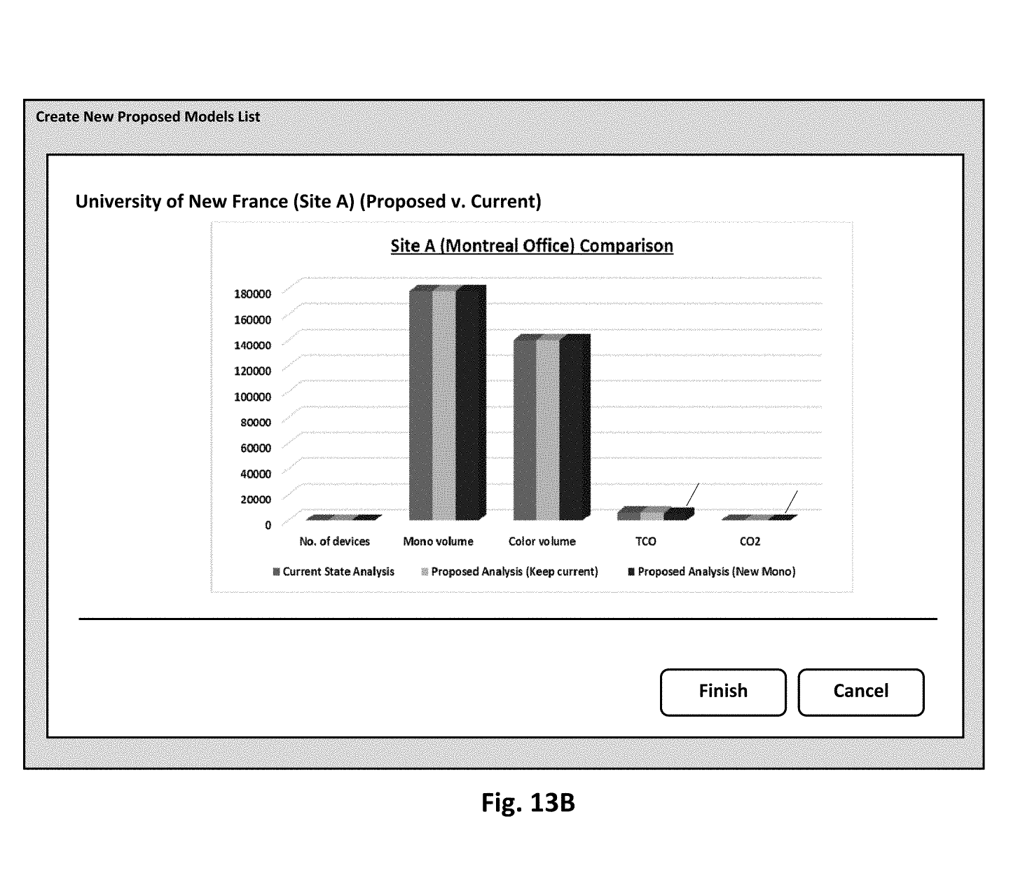

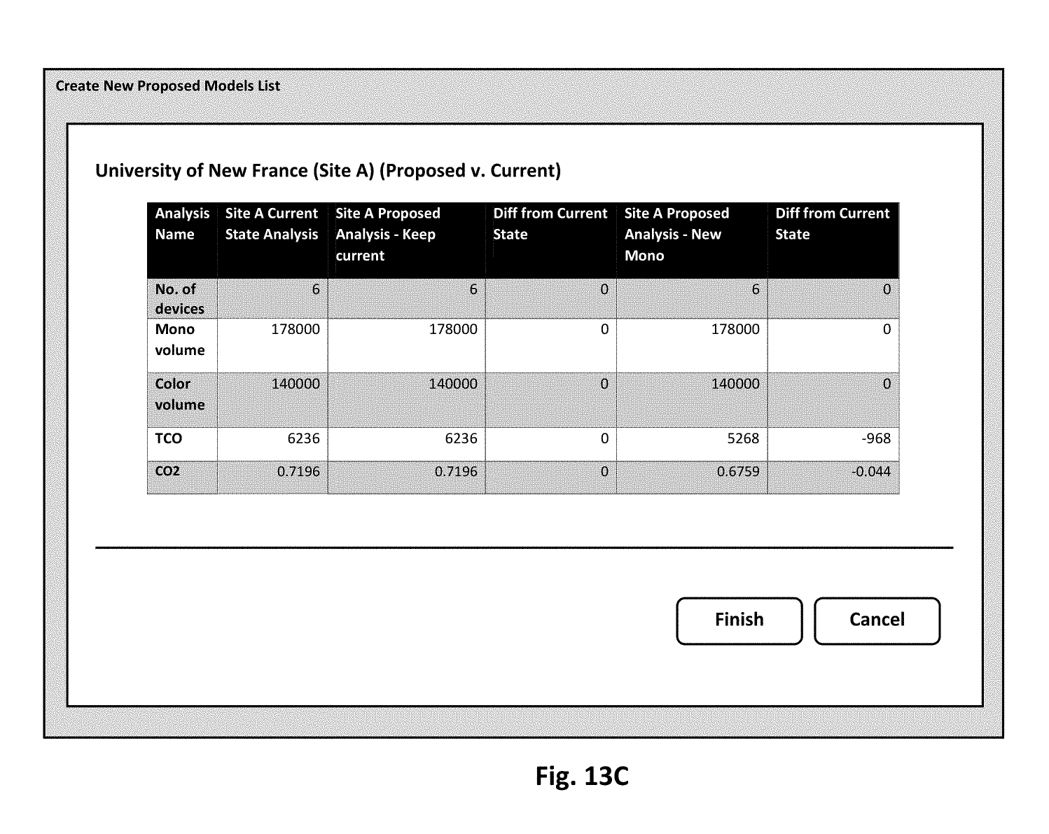

In one scenario, the user Harold may wish to perform a side-by-side comparison of the different state analyses that he has previously created. In this case the user Harold is creating a report to show one of the customers (i.e. “University of New France”) of Ricoh the changes that can be made to their current fleet of devices (S1200). Thus, the user Harold may activate the “Site Report” button, such as shown previously in FIG. 9B. Next, the user Harold is presented with one or more state analyses, such as shown in FIG. 13A. In this case, the user Harold can select two or more of the state analyses. It should be noted that the user Harold can compare any state analyses that he has previously created including current state analyses and proposed state analyses. After the user Harold has selected two or more state analyses (S1201), the device fleet analysis application calculates the difference between the selected state analyses in terms of costs, resource consumption, and waste generation (S1202) and generate and present the report to user (S1203). In one exemplary embodiment, the site report generated is a bar chart, such as shown in FIG. 13B. In another exemplary embodiment, the site report generated is merely a numerical table, such as shown in FIG. 13C.

The orders in which the steps are performed in the aforementioned methods are not limited to those shown in the examples of FIGS. 7, 10 and 12, and may be switched as long as similar results are achieved. Also, it should be noted that the methods or processes illustrated in the examples of FIGS. 7, 10 and 12 may be implemented using any of the systems described in connection with FIGS. 1A-1C.

The aforementioned specific embodiments are illustrative, and many variations can be introduced on these embodiments without departing from the spirit of the disclosure or from the scope of the appended claims. For example, various aspects, features and advantages disclosed herein can applied to automate guest or casual printing, even when the user is not aware of any local provisions of print functionality. Further, although the aspects, features and advantages are discussed herein in connection with a print application, it should be understood that such aspects and feature may be integrated in one or more programs that are not application software per se, but may be instead, for example, an operating system component, a snap-in, a plug-in, an add-on, an extension, or another program not normally referenced as an application.

In addition, elements and/or features of different examples and illustrative embodiments may be combined with each other and/or substituted for each other within the scope of this disclosure and appended claims.

What is claimed is:

1. A device fleet analysis application including one or more programs of instructions embodied in a non-transitory computer readable medium and executable by a computer to configure the computer to comprise:
a fleet adjustment user interface (UI) to permit a user to select a fleet of image forming devices from (a) a current state analysis for a current fleet of image forming devices in an enterprise or enterprise site or (b) a registered state analysis for a proposed fleet of image forming devices, and to revise the selected fleet of image forming devices, including UI parts to add devices to, modify devices in, and remove devices from the selected fleet of image forming devices; and
a fleet analysis module that generates a proposed state analysis for the revised fleet of image forming devices.

2. The device fleet analysis application as claimed in claim 1, the fleet adjustment UI includes a state analysis request part for the user to request one or more revised state analyses of the revised fleet of image forming devices, and to request a side-by-side comparison of two or more specified state analyses amongst the current state analysis, the registered state analysis and the revised state analyses.

3. The device fleet analysis application as claimed in claim 1, wherein the side-by-side comparison includes for each specified state analysis other than the current state analysis, showing of difference between the current state analysis and the specified state analysis.

4. The device fleet analysis application as claimed in claim 2, wherein the fleet adjustment UI includes a comparison selection part to specify one of a building, a floor, a workgroup, a business unit, a department and a cost center for the side-by-side comparison.

5. The device fleet analysis application as claimed in claim 1, wherein the fleet adjustment UI includes a multiple proposal part to request multiple proposed state analyses, based on the current fleet of image forming devices, including (a) an extend state analysis for the current fleet of image forming devices in which contractual terms are extended with price adjustment, (b) a replace mono state analysis in which only mono devices in the current fleet of image forming devices are proposed to be replaced by new models, and (c) a replace mono and color state analysis in which mono devices and color devices in the current fleet of image forming devices are proposed to be replaced by new models.

6. The device fleet analysis application as claimed in claim 1, wherein the fleet adjustment UI includes a multiple proposal part to request multiple proposed state analyses, based on the fleet of image forming devices of the registered state analysis, including (a) an extend state analysis for the current fleet of image forming devices in which contractual terms are modified with price adjustment, (b) a replace mono state analysis in which only mono devices in the fleet of image forming devices are proposed to be replaced by new models, and (c) a replace mono and color state analysis in which mono devices and color devices in the fleet of image forming devices are proposed to be replaced by new models.

7. The device fleet analysis application as claimed in claim 1, wherein each of the current state analysis, the registered state analysis and the proposed state analysis includes total cost of ownership (TCO) and a CO2 index.

8. A device fleet analysis application including one or more programs of instructions embodied in a non-transitory computer readable medium and executable by a computer to configure the computer to comprise:
a fleet analysis module that retrieves a current state analysis registered in a fleet data repository for a current fleet of image forming devices in an enterprise or enterprise site, and generates, based on the retrieved current state analysis, an initial proposed state analysis corresponding to a proposed fleet of image forming devices for the enterprise or enterprise site, in which the initial proposed state analysis is generated with objectives of same number of color output volume, same number of mono output volume and same number of devices as those in the retrieved current state analysis; and
a fleet adjustment user interface (UI) to revise the proposed fleet of image forming devices, including UI parts to add devices to, modify devices in, and remove devices from the proposed fleet of image forming devices.

9. The device fleet analysis application as claimed in claim 8, the fleet adjustment UI includes a state analysis request part for the user to request one or more revised state analyses of the revised fleet of proposes image forming devices, and to request a side-by-side comparison of two or more state analyses amongst the current state analysis, the initial proposed state analysis and the revised state analyses.

10. The device fleet analysis application as claimed in claim 9, wherein the side-by-side comparison includes for each proposed state analysis, showing of difference between the current state analysis and the proposed state analysis.

11. The device fleet analysis application as claimed in claim 9, wherein the fleet adjustment UI includes a comparison selection part to specify one of a building, a floor, a workgroup, a business unit, a department and a cost center for the side-by-side comparison.

12. The device fleet analysis application as claimed in claim 8, wherein the fleet adjustment UI includes a multiple proposal part to request multiple proposed state analyses based on a selected proposed state analysis already generated, including (a) an extend state analysis in which the fleet of image forming devices is the same as that of the selected proposed state analysis and contractual terms are extended with price adjustment, (b) a replace mono state analysis in which only mono devices in the fleet are proposed to be replaced by new models, and (c) a replace mono and color state analysis in which mono devices and color devices in the fleet are proposed to be replaced by new models.

13. The device fleet analysis application as claimed in claim 8, wherein the fleet adjustment UI includes a multiple proposal part to request multiple proposed state analyses based on the current state analysis, including (a) an extend state analysis in which the fleet of image forming devices is the same as that of the current state analysis and contractual terms are extended with price adjustment, (b) a replace mono state analysis in which only mono devices in the fleet are proposed to be replaced by new models, and (c) a replace mono and color state analysis in which mono devices and color devices in the fleet are proposed to be replaced by new models.

14. The device fleet analysis application as claimed in claim 8, the fleet adjustment UI permits modification of at least one of device options and accessories of a device amongst the proposed fleet of image forming devices.

15. A method performed by a device fleet analysis application including one or more programs of instructions embodied in a non-transitory computer readable medium and executing on a computer, the method comprising:
registering a current state analysis for a current fleet of image forming devices in an enterprise or enterprise site, and an already-generated state analysis for a proposed fleet of image forming devices;
providing a fleet adjustment user interface (UI) to permit a user to select a fleet of image forming devices from (a) the current fleet of image forming devices and (b) the proposed fleet of image forming devices, and to revise the selected fleet of image forming devices, and to add devices to, modify devices in, and remove devices from the selected fleet of image forming devices; and
generating a proposed state analysis for the revised fleet of image forming devices.

16. The method as claimed in claim 15, further comprising:
receiving through the fleet adjustment UI a request to generate one or more revised state analyses of the revised fleet of image forming devices; and
generating a side-by-side comparison of two or more specified state analyses amongst the current state analysis, the registered state analysis and the revised state analyses,
the side-by-side comparison including for each specified state analysis other than the current state analysis, showing of difference between the current state analysis and the specified state analysis.

17. The method as claimed in claim 15, further comprising:
receiving through the fleet adjustment UI a request to generate multiple proposed state analyses, based on the current fleet of image forming devices,
the multiple proposed state analyses including (a) an extend state analysis for the current fleet of image forming devices in which contractual terms are extended with price adjustment, (b) a replace mono state analysis in which only mono devices in the current fleet of image forming devices are proposed to be replaced by new models, and (c) a replace mono and color state analysis in which mono devices and color devices in the current fleet of image forming devices are proposed to be replaced by new models.

18. The method as claimed in claim 15, further comprising:
receiving through the fleet adjustment UI a request to generate multiple proposed state analyses, based on the fleet of image forming devices of the registered state analysis,
the multiple proposed state analyses including (a) an extend state analysis for the current fleet of image forming devices in which contractual terms are modified with price adjustment, (b) a replace mono state analysis in which only mono devices in the fleet of image forming devices are proposed to be replaced by new models, and (c) a replace mono and color state analysis in which mono devices and color devices in the fleet of image forming devices are proposed to be replaced by new models.
